(19) United States
(12) Patent Application Publication
(10) Pub. No.: US 2026/0010836 A1
(43) Pub. Date: Jan. 8, 2026

(54) METHOD FOR TRAINING LLMS BASED RECOMMENDER SYSTEMS USING KNOWLEDGE DISTILLATION, RECOMMENDATION METHOD FOR HANDLING CONTENT RECENCY WITH LLMS, SOLVING IMBALANCED DATA WITH SYNTHETIC DATA IN IMPERSONATION AND DEPLOYING STATE OF THE ART GENERATIVE AI MODELS FOR RECOMMENDATION SYSTEMS

(71) Applicant: Meta Platforms, Inc., Menlo Park, CA (US)

(72) Inventors: Mustafa Canim, Santa Clara, CA (US); Bahram Pourtaherian, San Francisco, CA (US); Simin Ahmadi Karvigh, Santa Clara, CA (US); Akshay Sarvesh, Mountain View, CA (US); Lingfei Zhao, Inglewood, CA (US); Christian Sousa Rodriguez, Cupertino, CA (US); Michael Kulinich, San Jose, CA (US); Jian Sean Huang, San Diego, CA (US); Haotian Wang, Bellevue, WA (US); Kourosh Modarresi, Sunnyvale, CA (US)

(21) Appl. No.: 19/255,594

(22) Filed: Jun. 30, 2025

Related U.S. Application Data
(60) Provisional application No. 63/667,008, filed on Jul. 2, 2024.
(60) Provisional application No. 63/675,049, filed on Jul. 24, 2024.
(60) Provisional application No. 63/676,103, filed on Jul. 26, 2024.
(60) Provisional application No. 63/676,201, filed on Jul. 26, 2024.

(51) Int. Cl. G06N 20/20

(52) U.S. Cl. CPC G06N 20/20

(57) ABSTRACT

A system and method for facilitating training of large language model based recommender systems are provided. The system may utilize one or more LLMs to create probability distributions for binary classification tasks associated with specific user-item pairs. The probabilities may be utilized to rank one or more tasks directly. The training of the one or more LLMs may involve the use of Knowledge Distillation methods and may be based on incorporating a dual-label system such as, for example, hard labels and soft labels. The one or more LLMs training data may consist of user-item pairs and their corresponding features. The labels used in the training process may include binary classification labels and their respective probabilities. The system may further implement the trained one or more LLMs to determine rankings or recommendations associated with user engagement of one or more content items.

### CROSS-REFERENCE TO RELATED APPLICATIONS

This application claims the benefit of U.S. Provisional Application No. 63/667,008, filed Jul. 2, 2024, and U.S. Provisional Application No. 63/675,049, filed Jul. 24, 2024, and U.S. Provisional Application No. 63/676,103, filed Jul. 26, 2024, and U.S. Provisional Application No. 63/676,201, filed Jul. 26, 2024, the entire contents of which are incorporated herein by reference.

### TECHNOLOGICAL FIELD

Exemplary embodiments of this disclosure may relate generally to methods, apparatuses and computer program products for facilitating training of large language model (LLM) based recommender systems.

### BACKGROUND

Current search and recommendation models in the virtual reality (VR) space may fall short in identifying the temporal aspect of VR engagement data such as understanding the order of search actions followed by entitlement events. However user's sequential behaviors, such as entitlements, application (app) interactions, surface engagements and search actions, may offer important/beneficial insights. In addition to the temporal aspect, current models may fail to capture the complex, semantically-rich sequential behaviors of users in the VR environment. For instance, app entitlement may be a natural outcome of low intent or high intent search actions. Once trained with a large amount/quantity (e.g., millions) of user action sequences, large language models (LLMs) may capture semantic similarities across users' behaviors and may predict which content may be the best based on a users' journey in the VR world. To address this issue, it may be possible to fine-tune discriminative language models like a language model based on a transformer architecture to generate user and content embeddings. However, the limited context window size of these models may pose a challenge in capturing the rich temporal signals inherent in user actions and detailed user features. Furthermore, the necessity for task-specific training of discriminative models may add to the complexity of training and maintenance.

### BRIEF SUMMARY

This disclosure introduces a novel approach to ranking and recommendation models, leveraging LLMs and user-item engagement data. The model(s) of the exemplary aspects of the present disclosure may diverge from traditional LLM applications in recommendation systems, which may typically generate direct recommendations or embeddings for downstream tasks.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary model architecture in accordance with an example of the present disclosure.

FIG. 2 illustrates a diagram of exemplary Area Under the Curve scores used to compare two models in accordance with an example of the present disclosure.

FIG. 3 illustrates an example system, in accordance with an example of the present disclosure.

FIG. 4 illustrates an example dual encoder model, in accordance with an example of the present disclosure.

FIG. 5 illustrates an example method, in accordance with an example of the present disclosure.

FIG. 6 illustrates an example computing device, in accordance with the present disclosure.

FIG. 7 illustrates a machine learning and training model, in accordance with the present disclosure.

FIG. 8 illustrates an example system, in accordance with an example of the present disclosure.

FIG. 9 illustrates an example method, in accordance with an example of the present disclosure.

FIG. 10 illustrates an example flow, in accordance with an example of the present disclosure.

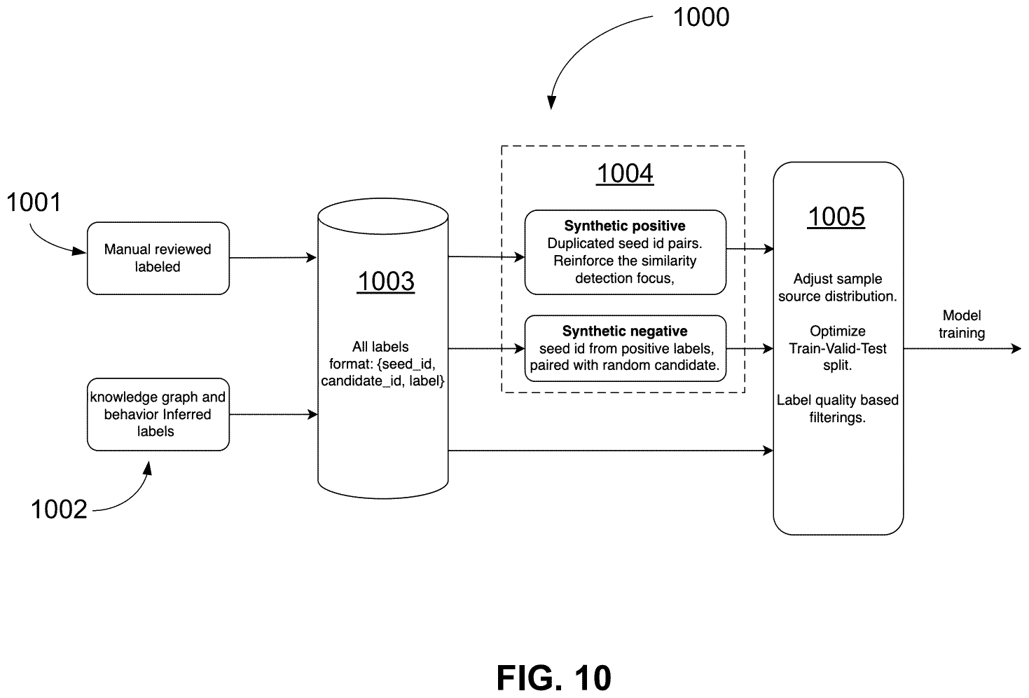

FIG. 11 illustrates an example computing device, in accordance with the present disclosure.

FIG. 12 illustrates a machine learning and training model, in accordance with the present disclosure.

FIG. 13A illustrates an example method, in accordance with an example of the present disclosure.

FIG. 13B illustrates another example method, in accordance with an example of the present disclosure.

FIG. 14 illustrates an example flowchart, in accordance with an example of the present disclosure.

FIG. 15 illustrates a machine learning and training model, in accordance with the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

### A. A Method for Training Large Language Model Based Recommender Systems Using Knowledge Distillation

It is to be understood that the methods and systems described herein are not limited to specific methods, specific components, or to particular implementations. It is also to be understood that the terminology used herein is for the purpose of describing particular embodiments only and is not intended to be limiting.

Some examples of existing technology and some limitations of these existing approaches are provided below.

Sparse Techniques: Traditional machine learning techniques like collaborative filtering, Sparse Neural Networks (SparseNN), and tree-based methods may not consider the deeper semantic connections within the data. In contrast, models based on LLMs may leverage self-attention mechanisms to distinguish and process the intricate semantic meanings of tokens. This advanced understanding may allow LLMs to make more sophisticated inferences, revealing complex similarities among users and content that traditional methods may not capture. Consequently, LLMs may provide recommendations that are more refined and tailored, based on a deep interpretation of content and user interactions.

Graph Models: Static representations in models like translating embeddings (TransE) models may miss out on the temporal dynamics and semantic relationships between user actions. Integrating the element of time into the analysis of user behavior may differentiate the weight of actions such as, for example, searches conducted at various times, giving precedence to those performed more recently. This temporal consideration may mean that a keyword searched for example yesterday may influence the recommendation algorithm/application more strongly than a keyword searched/looked up 6 weeks ago, which may ensure the suggestions remain current and relevant to the user's most immediate interests.

Descriptive Encoder Models: The process of fine-tuning descriptive models, such as language models based on a transformer architecture and its variants, may be employed to generate user content embeddings, which may be subsequently utilized in downstream tasks. However, a significant limitation of language models based on transformer architecture-based mechanisms may be the context window size. These models may typically have a window size restricted to 512 or 1,000 (1K) tokens, while modern LLMs may accommodate up to 128,000 (128K) tokens. This constraint may limit the volume of rich user features and sequences of user actions that may be input into the model. Another drawback may be the necessity for fine-tuning a new model for each task, which may restrict the model's flexibility. Additionally, maintaining the freshness of the encoders may present a challenge.

### Exemplary System Architecture

This disclosure introduces a novel approach(es) to ranking and recommendation models, leveraging LLMs and user-item engagement data. The model(s) of exemplary aspects of the present disclosure may diverge from traditional LLM applications in recommendation systems, which may typically generate direct recommendations or embeddings for downstream tasks. Instead, the exemplary aspects of the present disclosure may utilize LLMs to create/generate probability distributions for binary classification tasks associated with specific user-item pairs. These probabilities may later be used for ranking tasks directly. The training of the LLM model(s) may involve the use of Knowledge Distillation methods and may incorporate a dual-label system such as, for example, hard labels and soft labels. The model's training data may consist of user-item pairs and their corresponding features. The labels used in the training process may include binary classification labels and their respective probabilities.

Given that the ground truth data may only provide binary information (e.g., whether a user purchased an item or not), require an external data source to obtain probabilities. To address this, the system of the exemplary aspects may employ a knowledge distillation method, positioning the LLM model(s) as a student model and a Multi-Task Machine Learning (MTML) (e.g., a SparseNN) model as the teacher model.

In the training approach of the exemplary aspects of the present disclosure, the concept of hard labels and soft labels may be introduced to the system and/or utilized by the system. Soft labels may be derived from the MTML model and may be accompanied by probabilities. In contrast, hard labels may originate from the actual ground truth data. The system of the exemplary aspects of the present disclosure may blend a hard label score with a soft label score using a weighted approach, represented as P_combined=W_hard(User_i−Item_j)+W_soft(User_i−Item_j).

The model(s) of the exemplary aspects of the present disclosure may select positive samples from historical user-app engagement data. Hard negatives, on the other hand, may be chosen from a set of apps (or other content types) that were displayed to the user in the last n days but in which the user may not have engaged with. This method of selecting hard negatives from impressions may be designed to mitigate the content recency problem. During the inference phase, the system of the exemplary aspects of the present disclosure may feed user-item features into the LLM(s) and may directly compute/determine the label(s) along with a probability score. This innovative approach to ranking and recommendation models offers a more effective system for user-item engagement.

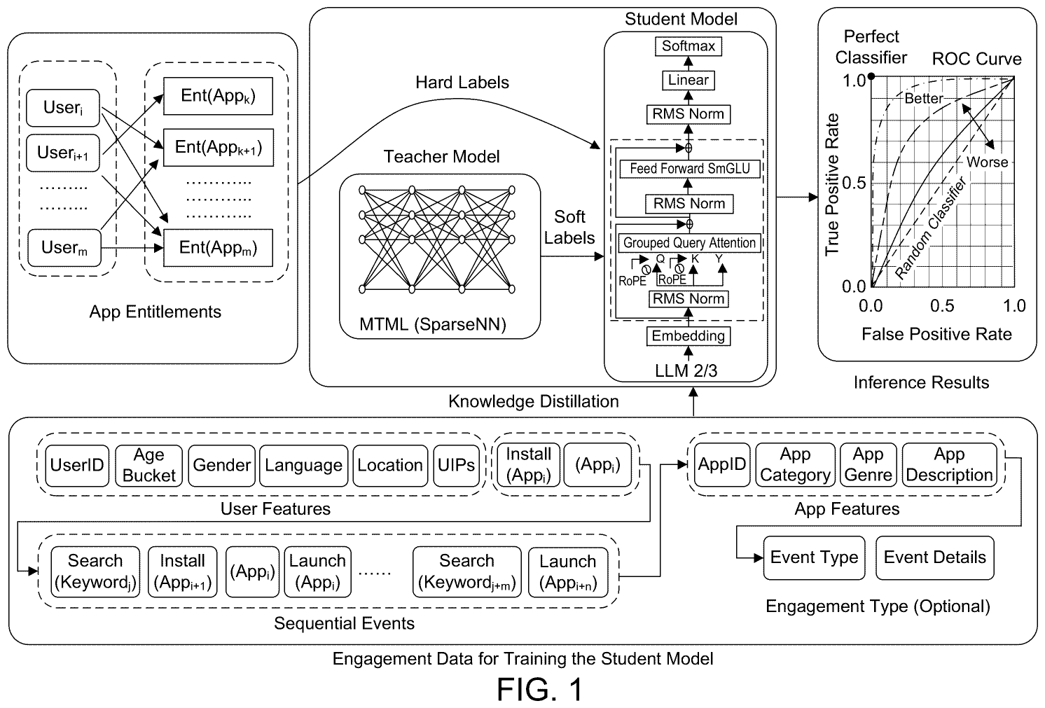

An additional benefit of the proposed method may be its ability to effectively address the cold start problem for both new users and newly released content. This is made possible due to use of semantic features of users and content. Traditional methods, such as collaborative filtering or content filtering, may often struggle with the cold start problem. However, the approach(es) of the exemplary aspects of the present disclosure may provide a robust solution to this challenge, enhancing the overall effectiveness and adaptability of the model. An example of the model architecture is provided in FIG. 1.

### Offline Evaluation

To assess the efficacy of the proposed method of the exemplary aspects of the present disclosure, the system may utilize VR user-content engagement data to train a first LLM, which served as the student model. In contrast, the system trained the SparseNN-based MTML model to act as the teacher model.

The MTML model may be trained using all available (or a subset of) user and app features for the tasks of entitlement and click prediction. This MTML model may be employed in a VR ranking app store and may be utilized/implemented to predict the likelihood of users entitling or clicking on an app.

The system of the exemplary aspects of the present disclosure may utilize 100,000 samples of user-app pairs to perform an inference(s) with the MTML to generate/determine probability scores. These probability scores may then be combined with hard labels to create a weighted probability score. These weighted probability scores, along with user-app features, may be subsequently fed into a second LLM.

The system of the exemplary aspects of the present disclosure may then use both the teacher model (e.g., MTML) and the student model (e.g., the first LLM) to generate binary classification results for a large quantity/amount (e.g., 1 million) of user-app pairs, along with their associated probabilities.

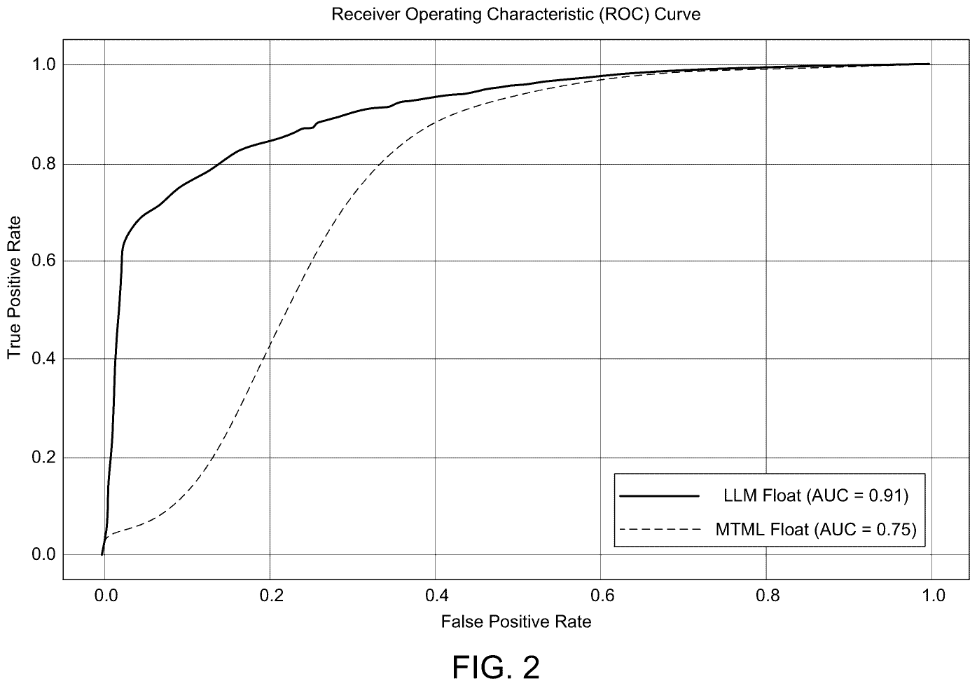

The Area Under the Curve (AUC) scores, which may be used to compare these two models, are illustrated in the graph shown in FIG. 2. As demonstrated in experiments, the AUC score(s) for the proposed method surpasses that of the MTML model, thereby validating the effectiveness of the proposed method of the exemplary aspects of the present disclosure.

### System Benefits

This method(s) of the exemplary aspects of the present disclosure may be beneficial for entities such as, for example, social networking systems, social media systems and/or the broader industry for several reasons.

Improved User Experience: By leveraging LLMs and knowledge distillation, this method may provide more accurate and personalized recommendations. This may lead to a better user experience, as users may be more likely to engage with content that aligns with their interests and preferences.

Addressing the Cold Start Problem: The cold start problem, in which it may be challenging to make accurate recommendations for new users or newly released content due to a lack of historical data, is typically a common issue in recommendation systems. The method(s)'s, of the exemplary aspects of the present disclosure, ability to handle the cold start problem may significantly improve the effectiveness of these recommendation systems.

Cross-Application Potential: While the method(s) of the exemplary aspects of the present disclosure may have applications in recommendation systems, it may also be applied to other areas such as, for example, search engines, advertising (ad) targeting, and/or content curation. This broad applicability may make the method(s) a valuable tool for a wide range of industries.

In summary, the method(s) of the exemplary aspects of the present disclosure may represent a significant advancement in the field of recommendation systems, with the potential to drive improvements in user experience, system efficiency, and scalability.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

### B. Recommendation Method for Handling Content Recency Problem with Large Language Model Based Dual Encoder Model

### TECHNOLOGICAL FIELD

The present disclosure generally relates to methods, apparatuses, and computer program products for generating recommendations.

### BACKGROUND

Electronic devices are constantly changing and evolving to provide users with flexibility and adaptability. Many electronic devices may provide methods for users to search the internet via applications, web pages, platforms, or the like for information of interest to the user. Although a user may be able to search platforms, etc., many searches may lack the specificity that the user may need in regard to their search. Many platforms may utilize methods or techniques to help mitigate the lack of specificity or context in relation to a user search, however, often times these techniques may be insufficient or inconvenient to the user.

### SUMMARY

Various systems, methods, and devices are described for generating a recommendation.

Recommendations may include product recommendations, search results, content recommendations, or the like to a user, an online profile, or any other suitable type of online presence. The recommendation may be generated by a machine learning model utilizing a dual encoder model.

In various examples, systems and methods may receive an indication of a user's input associated with the user, such as interactions with a search(s), post(s), photo(s), video(s), website(s), online shop(s), reel(s), or one or more stories. User data may be captured in association to the user, wherein data may be captured continuously. A machine learning module may develop a recommendation associated with the input and relationship between user data and content. The machine learning model may utilize a dual encoder model to develop an association between user characteristics and content features, wherein the user data may refer to any data associated with user characteristics and temporal user data and user characteristics may refer to content attributes (e.g., engagement with applications, posts, videos, application genre, application category, application description, etc.). A recommendation may be generated based on an association between the input and relationship determined via the dual encoder model. A machine learning module, which may be the same or different machine learning module, may generate the recommendation. The recommendation may include content associated with a platform (e.g., a third-party platform, website, or the like).

The dual encoder model may comprise two neural network towers, where the first tower may comprise user data associated with user actions and the second tower may comprise content attributes. The data of the first tower and the second tower may be used to train two large language models (e.g., a first large language model and a second large language model) based on their respective datasets. In various examples, the dual encoder model may develop associations between user characteristics, associated with the first tower, and a predicted user action, associated with the second tower. The dual encoder may aid in the training of a machine learning model to determine a recommendation to a user based on a received input. The recommendation may be generated and provided on a graphical interface of a device (e.g., computing device, communication device, or the like). The recommendation may be in the form of an image, video, text, email, message, response to search, or any combination thereof. In various examples, the dual encoder model may utilize similar user data to aid in the determination of a relationship between user data and a predictive action associated with a user.

Various systems, methods, and devices are described for generating a recommendation, via a recommendation platform. Systems and methods may receive an indication of a user's input associated with the user. Data associated with the user may be continuously captured and stored. A machine learning module may develop a recommendation associated with the input and relationship between user characteristics and content features. Where the machine learning model may employ a dual encoder model to develop an association between user characteristics and content features. A recommendation may be generated based on an association between the input and relationship determined via the dual encoder model. As a result, a recommendation may be provided to the user. The recommendation may include content associated with a platform (e.g., an third-party platform, website, or the like).

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### DESCRIPTION

Some examples of the present invention will now be described more fully hereinafter with reference to the accompanying drawings, in which some, but not all examples of the invention are shown. Indeed, various examples of the invention may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received or stored in accordance with examples of the invention. Moreover, the term “exemplary”, as used herein, is not provided to convey any qualitative assessment, but instead merely to convey an illustration of an example. Thus, use of any such terms should not be taken to limit the spirit and scope of examples of the invention.

Many electronic devices may provide methods for users to search the internet via applications, web pages, platforms, or the like for information of interest to the user. Although a user may be able to search platforms, etc., many searches may lack the specificity that the user may need in regard to their search. Many platforms may utilize methods or techniques to help mitigate the lack of specificity or context in relation to a user search, however, often times these techniques may be insufficient or inconvenient to the user.

Some platforms, applications, or companies have utilized the sparse technique or graph models to mitigate the problems that arise with search platforms. However, both methods may be insufficient. There may be a need for a more convenient and precise search function associated with user devices. Disclosed herein are method, systems, or apparatuses that may provide a recommendation platform. The recommendation platform may utilize a dual encoder model that employs large language models (LLMs) to provide more precise and convenient search results and recommendations to users. The recommendation platform may determine an association between an input and a user to generate a recommendation that may be of interest to the user based on a determined relationship between user data and predicted user actions, via the dual encoder model.

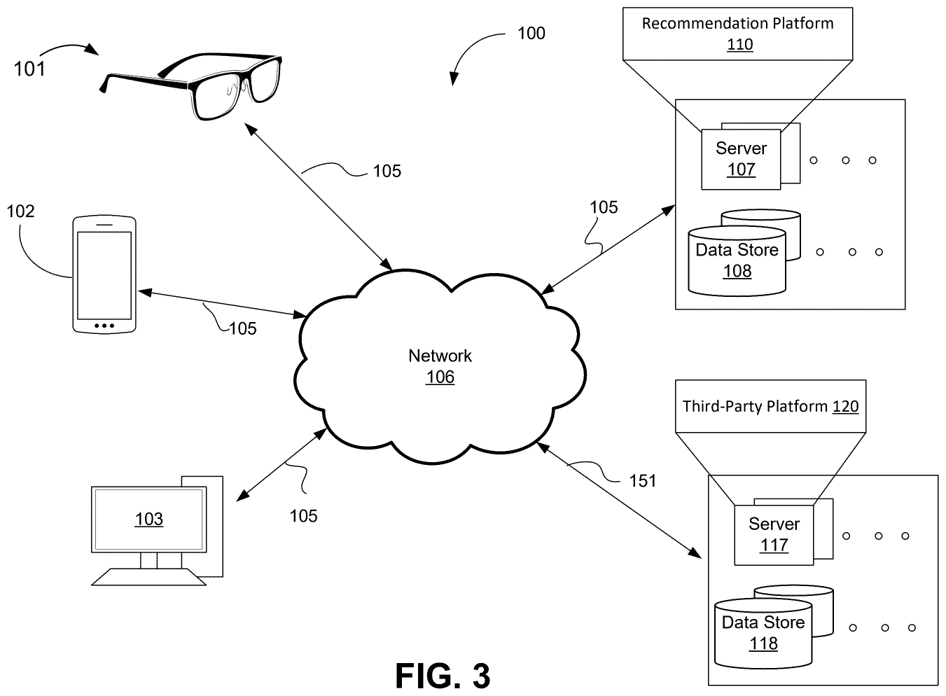

FIG. 3 illustrates an example system 300 that may implement a recommendation platform 310. System 300 may include one or more communication devices 301, 302, and 303 (also may be referred to as user devices), server 307, data store 308, recommendation platform 310, server 317, data store 318, or third-party platform 320. As shown for simplicity, recommendation platform 310 may be located on server 307 and third-party platform 320 may be located on server 317. It is contemplated that recommendation platform 310 or third-party platform 320 may be located on or interact with one or more devices of system 300. It is contemplated that recommendation platform 310 may be a feature or native component of third-party platform 320. Additionally, system 300 may include any suitable network, such as, for example, network 306.

This disclosure contemplates any suitable network 306. As an example and not by way of limitation, one or more portions of network 306 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. In some examples, network 306 may include one or more networks 306.

Links 305 may connect device 301, 302, 303, third-party platform 320, and/or recommendation platform 310 to network 306 and/or to each other. This disclosure contemplates any suitable links 305. In particular examples, one or more links 305 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular examples, one or more links 305 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 305, or a combination of two or more such links 305. Links 305 need not necessarily be the same throughout network 306 and/or system 300. One or more first links 305 may differ in one or more respects from one or more second links 305.

Devices 301, 302, 303 may be an electronic device including hardware, software, or embedded logic components or a combination of two or more such components and capable of carrying out the appropriate functionalities implemented or supported by the devices 301, 302, 303. As an example and not by way of limitation, devices 301, 302, 303 may be a computer system such as for example, a desktop computer, notebook or laptop computer, netbook, a tablet computer (e.g., smart tablet), e-book reader, global positioning system (GPS) device, personal digital assistant (PDA), handheld electronic device, cellular telephone, smartphone, augmented/virtual reality device, other suitable electronic device, or any suitable combination thereof. This disclosure contemplates any suitable device(s) (e.g., devices 301, 302, 303). One or more of the devices 301, 302, 303 may enable a user to access network 306. One or more of the devices 301, 302, 303 may enable a user(s) to communicate with other users at other devices 301, 302, 303.

In particular examples, system 300 may include one or more servers 307, 317. Each of the servers 307, 317 may be a unitary server or a distributed server spanning multiple computers or multiple datacenters. Servers 307, 317 may be of various types, such as, for example and without limitation, web server, news server, mail server, message server, advertising server, file server, application server, exchange server, database server, proxy server, another server suitable for performing functions or processes described herein, or any combination thereof. In particular examples, each of the servers 307, 317 may include hardware, software, or embedded logic components or a combination of two or more such components for carrying out the appropriate functionalities implemented or supported by server 307, 317.

In particular examples, system 300 may include one or more data stores 308, 318. Data stores 308, 318 may be used to store various types of information. In particular examples, the information stored in data stores 308, 318 may be organized according to specific data structures. In particular examples, each of the data stores 308, 318 may be a relational, columnar, correlation, or other suitable database. Although this disclosure describes or illustrates particular types of databases, this disclosure contemplates any suitable types of databases. Particular examples may provide interfaces that enable devices 301, 302, 303 or another system (e.g., a third-party system 320) to manage, retrieve, modify, add, or delete, the information stored in data store 308.

In particular examples, device 301, 302, 303 may be associated with an individual (e.g., a user) and third-party platform 320 may be associated with an application(s) that interact or communicates with recommendation platform 310. In some examples, recommendation platform 310 or third-party platform 320 may be considered, or associated with, an application (or an AR platform or a media platform or a function of a social media platform). In particular examples, one or more users may use one or more devices (e.g., devices 301, 302, 303) to access, send data to, or receive data from third-party platform 320 which may be located on a server 317. In some other examples, one or more users may use one or more devices (e.g., device 301, 302, 303) to send data to, or receive data from recommendation platform 310 which may be located on server 307, a device (e.g., device 301, 302, 303), or the like.

In particular examples, recommendation platform 310 may be a network-addressable computing system that may host an online search network. Recommendation platform 310 may generate, store, or receive user information (also referred herein as user data) associated with a user, such as, for example, user-profile data (e.g., user online presence), geographical location, previous searches, interactions with content, or other suitable data related to the recommendation platform 310. Recommendation platform 310 may be accessed by one or more components of system 300 directly and/or via network 306. As an example and not by way of limitation, device 301, 302, 303 may access recommendation platform 310 located on server 307 by using a web browser, feature of a third-party platform 320 (e.g., function of a social media application, function of an AR application), or a native application on device 301, 302, 303 associated with recommendation platform 310 (e.g., a mobile search application, a recommendation application, a messaging application, another suitable application, or any combination thereof) directly or via network 306.

In particular examples, recommendation platform 310 may store one or more user profiles associated with an online presence in one or more data store 308. In some other examples third-party platform 320 may also store one or more user profiles associated with an online presence in one or more data store 318. In particular examples, a user profile may include multiple nodes—which may include multiple user nodes (each corresponding to a particular user associated with a device 301, device 302, or device 303) or multiple concept nodes (each corresponding to a particular role or concept)—and multiple edges connecting the nodes. Users of the third-party platform 320 may have the ability to communicate and interact with other users. In particular examples, users may join the third-party platform 320 and then add connections (e.g., relationships) to a number of other users of third-party platform 320 to whom they want to be connected. User connections or communications may be monitored via recommendation platform 310 or any other suitable component of system 300. In an example, server 307 of recommendation platform 310 or server 317 of third-party platform 320 may receive, record, or otherwise obtain information associated with communications or connections of users (e.g., device 301, device 302, or device 303). As such, the monitored connections or communications may be utilized for determining trends related to a user's interest associated with a product.

In particular examples, third-party platform 320 may be a network-addressable computing system that may host an online social media platform, marketplace, shop, and/or the like. Third-party platform 320 may generate, store, receive, or sends user information (also referred herein as user data) associated with a user, such as, for example, user-profile data (e.g., user online presence), geographical location, or other suitable data related to the recommendation platform 310. Third-party platform 320 may be accessed by one or more components of system 300 directly or via network 306. As an example and not by way of limitation, device 301, 302, 303 may access third-party platform 320 located on server 317 by using a web browser or a native application (e.g., a mobile social networking application, a messaging application, another suitable application, or any combination thereof) either directly or via network 306.

In particular examples, third-party platform 320 may provide users with the ability to take actions on various types of content items. As an example and not by way of limitation, the items may include posts, videos, images, online marketplaces, texts, or other suitable items. A user may interact with any item(s) that may be capable of being represented in third-party platform 320. As such, interactions with or in third-party platform 320 may be recorded via recommendation platform 310.

Third-party platform 320 may include generated content objects (e.g., user-generated, web-generated, AI-generated, or the like or any combination thereof), which may enhance a user's interactions with third-party platform 320. Generated content may include any data a user may add, search, upload, send, interact with, or “post” that is made available publicly or privately to third-party platform 320. As an example and not by way of limitation, a user may communicate posts to third-party platform 320 from a device 301, 302, 303. Posts may include data such as textual data, photos, videos, audio, links, or other similar data or media associated with users and is available to third-party platform 320. A search may include data such as textual data, photos, videos, audio, links, or other similar data or media associated with an input provided by a user.

Although FIG. 3 illustrates a particular arrangement of device 301, 302, 303, network 306, third-party platform 320, server 307, server 317, data store 308, data store 318, or recommendation platform 310, among other things, this disclosure contemplates any suitable arrangement. The devices of system 300 may be physically or logically co-located with each other in whole or in part.

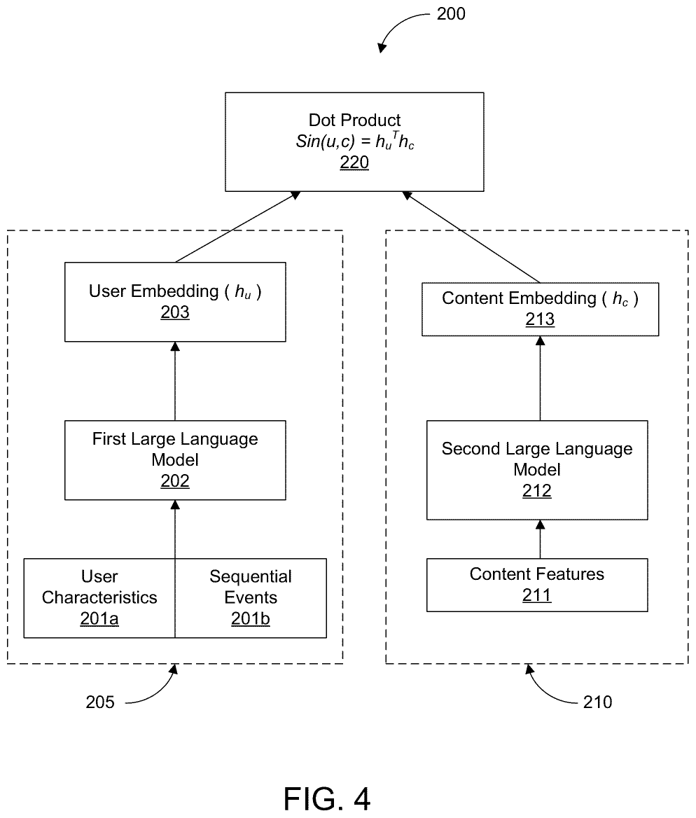

FIG. 4 illustrates an example dual encoder model 400, in accordance with an example of the present disclosure. The dual encoder model 400 may comprise two neural network towers, wherein the first tower 405 may be configured to produce user embeddings 403 (hᵤ) and the second tower 410 may be configured to produce content embeddings 213 (h_{c}). The neural network towers (e.g., first tower 405 and second tower 410) may be trained on historical data, user data, user engagement data. application data, or the like. In some examples, historical data may comprise but not limited to books, movies, news articles, magazines, tv shows, or the like. Dual encoder 400 may assist with machine learning techniques to develop a recommendation based on an association between user embeddings 403 and content embeddings 413. For example, the dual encoder model 400 may be trained on data indicating various types of datapoints, such as, user interest, application data, user engagement, user data, and the like. It is contemplated that one or more dual encoder models 400 may be trained and applied to determine such associations or to perform operations. The first tower 405 and the second tower 410 may both comprise a machine learning model. The machine learning may be a large language model (LLM) (e.g., a first LLM 402 and a second LLM 412 respectively). In some examples, the machine learning model of the first tower 405 and the second tower may be any suitable LLM such as but not limiting to, large language models for generative artificial intelligence that may utilize artificial neural networks in natural language processing, as well as decoder transformer based large language models, or any other suitable large language model(s). The first LLM 402 may be configured to embed data associated with user characteristics 401a and sequential events 401b. the second LLM 412 may be configured to embed data associated with content features. In some examples, the embedded data (e.g., user embedding 403 and content embeddings 413 may be utilized to train one or more machine learning models. The embedded data from the first LLM 402 (e.g., user embedding 403) and the second LLM 412 (e.g., content embedding 413) may be combined via a mathematical operation (e.g., dot product 420). The dot product 420 may be a numerical expression associated with the users' interests, likes, device or app usage, or the like, or any combination thereof. The dot product 420 may be utilized by the machine learning system to determine a recommendation to a user.

In some examples, the user embeddings 403 and content embeddings 413 may be utilized to train other machine learning models or for cosine-based similarity to rank user/content pairs for generating a recommendation. Embeddings are representations of values or items such as text, images, audio, or the like that may be designed to be consumed by machine learning models and semantic search algorithms. Embeddings may translate items into a mathematical form (e.g., vectors) according to the factors or traits each one may or may not have, and the categories they belong to. The numerical form of embeddings may make it possible for computers to understand the relationships between words and other items. In some examples, embeddings may be configured to provide machine learning models a method or value to find similar items. For example, given a photo or a document, a machine learning model that uses embeddings may find a similar photo or document.

The dual encoder model 400 may be a neural network that utilizes binary classification to find the closeness between the first tower 405 (e.g., user characteristics 401a) and the second tower 410 (e.g., content features 411). In dual encoder model 400 may be a contrastive loss-based model where the dot product 420 of the user embeddings 403 and content embeddings 413 may be used to maximize positive samples and conversely, the dot product 420 of the user embeddings 403 and content embeddings 413 may be minimized for negative samples. The positive samples may be selected from historical data gathered from user engagements whereas negative samples may be apps a user has not engaged with or has not used in “M” number of days, where “M” may be any suitable number determined by the recommendation platform 310. In some examples the dual encoder may be trained on the positive and negative samples associated with historical data and user engagements.

The first tower 405 may comprise data associated with a user's past actions, wherein historical data may be assessed and/or stored to train a first LLM 402. The user's past actions may include datapoints such as user characteristics 401a and sequential events 401b (e.g., temporal data). User characteristics 401 may include one or more of user identification (e.g., user profile), user age group, user gender, user language, user location, or any other suitable data or any combination thereof. Sequential events 401b may include one or more of app installation data, application metadata, search data, application launch data, or any other suitable data of any combination thereof. Sequential data may be associated with time, for example, user interactions with an app within a time period may be utilized. The time period may be any suitable time period determined by the system 300, wherein the time period may be second, minutes, days, weeks, months, or any other increment of time.

The second tower 410 may comprise data associated with content features 411, wherein content features may include one or more of application features, user application engagement, or the like. Data associated with content features 411 may be utilized to train a second LLM 412. Application features may include one or more datapoints such as, application identification, application category, application genre, application description, or any other suitable application data. User engagement may include event type, event details, user impressions with an application (e.g., whether the user has interacted with an application or not), or any other suitable Information. The second tower 410 may be configured to utilize application features and engagement type data to predict a user action. For example, a user may have installed 10 AR games in the past and searched for 20 keywords in the past, based on this captured data, the second tower 410 may predict the next app or AR game the user is most likely to purchase.

The first LLM 402 and the second LLM 412 may be configured to understand the sequential ordering of data based on time via self-attenuation mechanisms. The first LLM 402 and second LLM 412 may be trained on millions of datapoints associated with a plurality of users (e.g., user engagement), and application features, respectively.

In an example, the first LLM 402 may utilize temporal data and semantic features of users to aid in the determination of a recommendation. For example, a new game is released, based on the features of the new game or app (e.g., games description, game genre, game category), the features may be semantically interpreted by the first LLM 402 based on similar user data to a user and historical data associated with the user. The second LLM 412 may identify existing interactions of the user in relation to similar games based on the interpreted features. For example, a user has interacted with an application, the second LLM 412 has determined that there are similarities between the newly released game and the app, in terms of description, genres, categories, etc., therefore the user may be recommended the new game. A dot product 420 (e.g., sin (u,c)) of the results of the first LLM 402 and the second LLM 412 may determine that the user may have interest or like the new game as well.

Experiments have shown that the use of dual encoder models in machine learning systems have improved clickthrough rate (CTR) while reducing the volume of notifications when testing machine learning systems. Experiments yielded a significant increase in CTR for the alerts page and for push notifications, respectively. Overall, experiments have shown a reduced notification volume. As such, the usage of a dual encoder model may lead to improved content delivery (e.g., notifications, advertisements, messages, images, etc.) being sent to users (e.g., content of interest to users), while limiting content that may not be of interest to the user.

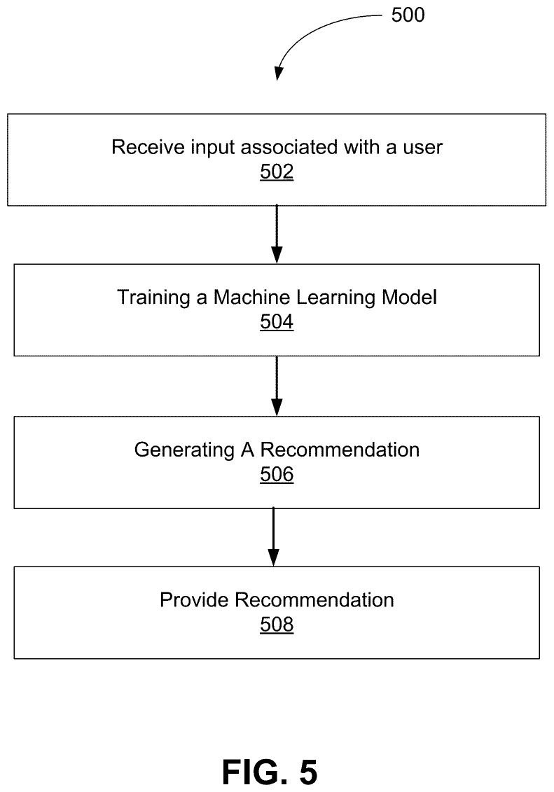

FIG. 5 illustrates an example method 500 for generating a recommendation, in example of the present disclosure. The method 500 may begin at 502, where an input associated with a user may be received via recommendation platform 510. The input may be associated with a user (e.g., device 301, device 302, or device 303), wherein the input may be provided via graphical user interface of a device.

At 504, a machine learning model may be trained based on a dual encoder model (e.g., dual encoder model 400). The dual encoder model (dual encoder model 400) may provide data associated with content features 411, user characteristics 401a, sequential events 401b, or any combination thereof to train one or more machine learning models. In some examples, the dual encoder model may be configured to determine associations between content features 411, user characteristics 401a, and sequential events 401b associated with a user (e.g., user past data and predicted user action data).

The dual encoder model 400 may comprise one or more large language models (e.g., first LLM 402, second LLM 412). The dual encoder model 400 may be configured to embed data associated with the user, similar users, interactions with content, device data, application data, historical data, user engagement or any suitable data to predict a future action (e.g., search, purchase, or the like). The dual encoder model 400 may be further configured to embed data to quantify or classify a user's past actions to aid in the generation of the recommendation. The dual encoder model 400 may be a neural network utilized to determine semantic data associated with past user actions to inform or aid in the generation of the recommendation.

At 506, a machine learning system may generate a recommendation. The generated recommendation may utilize data directly from the machine learning system, dual encoder model 400, user profile data, or a combination thereof. The generated recommendation may be a response to a search, a product, a post, a service, a similar user, a group of similar users, or the like. The machine learning system may include one or more machine learning models. The machine learning system may be utilized to generate a recommendation based on the received input. The machine learning system may comprise a dual encoder model 400 configured to aid in the determination of the recommendation. The machine learning system may associate content features, user characteristics, sequential events, content/user engagement, user data, or any combination thereof to inform the generation of the recommendation based on previously identified associations. In some examples, associations may be defined, e.g., in advance, using the dual encoder model 400, human input, etc., and may link one or more recommendations with one or more inputs received from a user. When such associations may not be available, supervised learning of dual encoder model 400 may not be possible. In such cases, self-supervised learning may be employed instead. For instance, generated content, may be split into two random sets (e.g., each set may contain a number of content items). In instances where the sets may be similar between a plurality of users, those users may be determined to be similar. In some examples, this relationship may be enough to provide supervision signal(s) for the dual encoder model 400.

At 508, a recommendation may be provided to a user, via a device (e.g., device 301, device 302, or device 303), for example, through or by a third-party platform (e.g., third-party platform 320) or recommendation platform 310 to a user's device. The recommendation may be provided by a device (e.g., device 301, device 302, or device 303) in the form of a search response, advertisement, pop-up alert, a post on a user-feed, an image, a video, text, banner on a home screen, or any other form of content. In some examples, the recommendation may be an alert or notification within an application, when interacting with a third-party platform (e.g., social media platform, business platform, banking platform, shopping platform, or the like). It may be appreciated that the method providing the recommendation may utilize any of a variety of techniques, and may be customizable, as desired. The content of the recommendation may be determined, via the analysis at block 504 by dual encoder model 400, based on the association between, user actions, user impressions, similar user actions, similar user impressions, or any other suitable data.

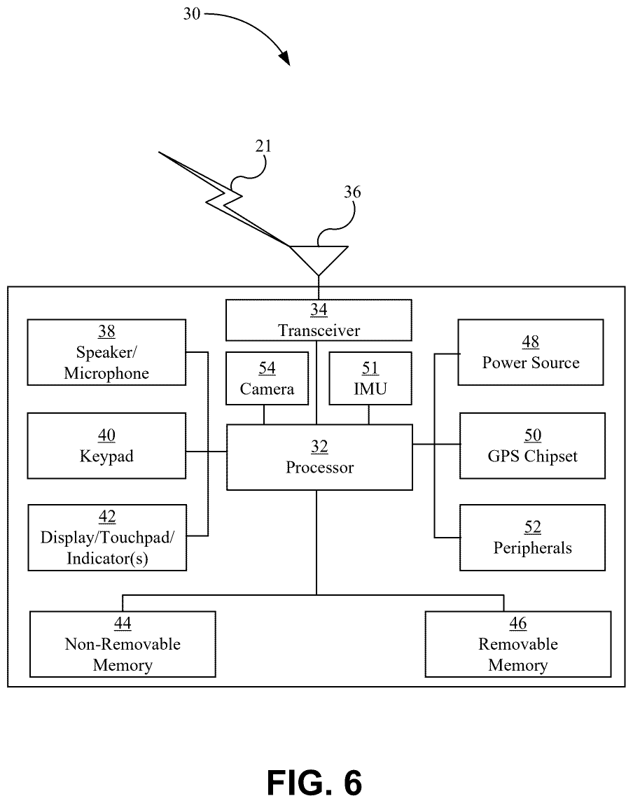

FIG. 6 illustrates a block diagram of an example hardware/software architecture of user equipment (UE) 30. As shown in FIG. 6, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, an inertial measurement unit (IMU) 51, and other peripherals 52. The UE 30 may also include a camera 54. In an example, the camera 54 is a smart camera configured to sense images appearing within one or more bounding boxes. The UE 30 may also include communication circuitry, such as a transceiver 34 and a transmit/receive element 36. It will be appreciated that the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an example, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another example, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

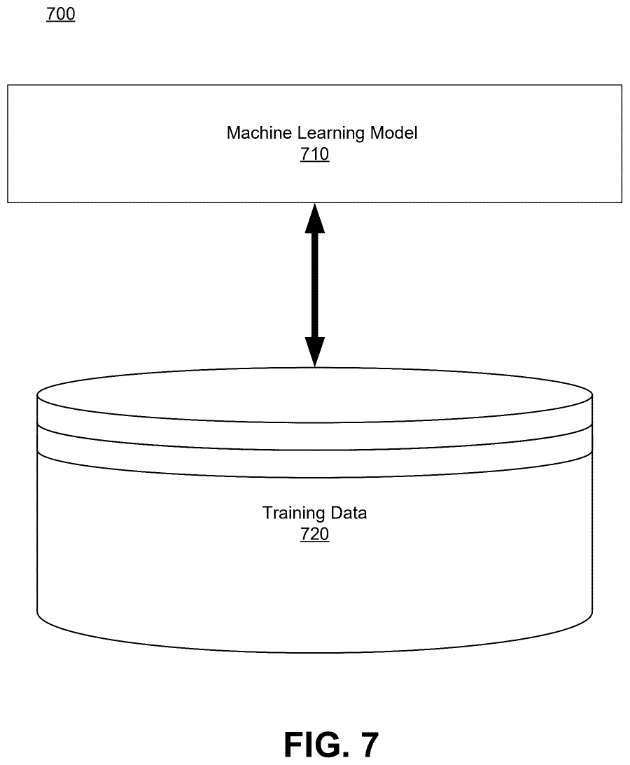

FIG. 7 illustrates a framework 700 that may be employed by the recommendation platform 310 associated with machine learning. The framework 700 may be hosted remotely. Alternatively, the framework 700 may reside within the third-party platform 320 or system 300 as shown in FIG. 3 or be processed by a device (e.g., devices 301, 302, 302). The machine learning model 710 may be operably coupled with the stored training data in a database (e.g., data store 308, data store 318). In some examples, the machine learning model 710 may be associated with other operations. The machine learning model 710 may be implemented by one or more machine learning models(s) (e.g., machine learning model generating the recommendation of block 506 of 404) or another device (e.g., server 307, server 317, or device 301, 302, 303).

In another example, the training data 720 may include attributes of thousands of objects. For example, the object may be a smart phone, person, book, newspaper, sign, car, item and the like. Attributes may include but are not limited to the size, shape, orientation, position of the object, etc. The training data 720 employed by the machine learning model 710 may be fixed or updated periodically. Alternatively, the training data 720 may be updated in real-time based upon the evaluations performed by the machine learning model 710 in a non-training mode. This is illustrated by the double-sided arrow connecting the machine learning model 710 and stored training data 720.

In operation, the machine learning model 710 may evaluate associations between an input and a recommendation. For example, an input (e.g., a search, interaction with a content item, etc.) may be compared with respective attributes of stored training data 720 (e.g., prestored objects and/or dual encoder model).

Typically, such determinations may require a large quantity of manual annotation and/or brute force computer-based annotation to obtain the training data in a supervised training framework. However, aspects of the present disclosure, deploys a machine learning model that may utilize a dual encoder model that may be flexible, adaptive, automated, temporal, learns quickly and trainable. Manual operations or brute force device operations are unnecessary for the examples of the present disclosure due to the learning framework and dual neural network model aspects of the present disclosure. As such, this enables the user recommendations of the examples of the present disclosure to be flexible and scalable to billions of users, and their associated communication devices, on a global platform.

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features described in connection with any one or more examples are not intended to be excluded from a similar role in any other examples.

It is to be understood that the methods and systems described herein are not limited to specific methods, specific components, or to particular implementations. It is also to be understood that the terminology used herein is for the purpose of describing particular examples only and is not intended to be limiting.

As used herein, the terms “data,” “content,” “information” and similar terms may be used interchangeably to refer to data capable of being transmitted, received and/or stored in accordance with examples of the disclosure. Moreover, the term “exemplary”, as used herein, is not provided to convey any qualitative assessment, but instead merely to convey an illustration of an example. Thus, use of any such terms should not be taken to limit the spirit and scope of examples of the disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, “artificial reality” may refer to a form of immersive reality that has been adjusted in some manner before presentation to a user, which may include, for example, a virtual reality, an augmented reality, a mixed reality, a hybrid reality, Metaverse reality or some combination or derivative thereof. Artificial reality content may include completely computer-generated content or computer-generated content combined with captured (e.g., real-world) content. In some instances, artificial reality may be associated with applications, products, accessories, services, or some combination thereof, that may be used to, for example, create content in an artificial reality or are otherwise used in (e.g., to perform activities in) an artificial reality.

As referred to herein, “artificial reality content” may refer to content such as video, audio, haptic feedback, or some combination thereof, any of which may be presented in a single channel or in multiple channels (such as stereo video that produces a three-dimensional (3D) effect to the viewer) to a user.

As referred to herein, a Metaverse may denote an immersive virtual/augmented reality world in which augmented reality (AR) devices may be utilized in a network (e.g., a Metaverse network) in which there may, but need not, be one or more social connections among users in the network. The Metaverse network may be associated with three-dimensional (3D) virtual worlds, online games (e.g., video games), one or more content items such as, for example, non-fungible tokens (NFTs) and in which the content items may, for example, be purchased with digital currencies (e.g., cryptocurrencies) and other suitable currencies.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

The scope of this disclosure encompasses all changes, substitutions, variations, alterations, and modifications to the example examples described or illustrated herein that a person having ordinary skill in the art would comprehend. The scope of this disclosure is not limited to the example examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

### C. Solving Imbalanced Data Problem with Synthetic Data in Impersonation Detection Model Training

### TECHNOLOGICAL FIELD

The present disclosure generally relates to methods, apparatuses, and computer program products for training machine learning models, specifically machine learning models configured to detect impersonations.

### BACKGROUND

Developments in technology have allowed for more communication and connection between users and entities (e.g., organizations) to be facilitated via online means (e.g., email, text messages, social media platforms, platforms, or the like, or any combination thereof). With the increase of communication and connections online it may be easy for an individual with nefarious intentions to impersonate an entity and capture information and data associated with a user for illegal uses.

### SUMMARY

Various systems, methods, and devices are described for rebalancing a training dataset associated with a machine learning model, where the machine learning model may be configured to determine an account that is impersonating another account.

In various examples, systems and methods of generating a plurality of synthetic data labels (also referred to herein as a plurality of synthetic data) to rebalance a training data set associated with a machine learning model. The training dataset may comprise a set of manual labels, a set of inferred labels, and the plurality of synthetic data labels. The plurality of synthetic data labels may include a plurality of synthetic negative data labels indicating no impersonation and a plurality of synthetic positive data labels indicating impersonation. The plurality of synthetic negative data labels generated may equal the number of real positive labels (e.g., of the set of manual labels and the set of inferred labels). The plurality of synthetic positive data labels may equal a number of unique seed identifiers (IDs), which indicate a number of unique users with a potential to be a victim of impersonation. The training dataset may train the machine learning model wherein the machine learning model may be configured to determine if a user is impersonating another.

Various systems, methods, and devices are described for rebalancing a training dataset associated with a machine learning model. In an example, a plurality of synthetic data labels may be generated to rebalance the training data set. The training dataset may comprise a set of manual labels, a set of inferred labels, and the plurality of synthetic data labels. The plurality of synthetic data labels may include a plurality of synthetic negative data labels indicating no impersonation and a plurality of synthetic positive data labels indicating impersonation. The plurality of synthetic negative data labels generated may equal the number of real positive labels (e.g., of the set of manual labels and the set of inferred labels). The plurality of synthetic positive data labels may equal a number of unique users with a potential to be a victim of impersonation. The training dataset may train the machine learning model configured to determine if a user is impersonating another.

### DESCRIPTION

Developments in technology have allowed for more communication and connection between users and entities (e.g., organizations) to be facilitated via online means (e.g., email, text messages, social media platforms, platforms, or the like, or any combination thereof). With the increase of communication and connections online it may be easy for an individual with nefarious intentions to impersonate an entity and capture information and data associated with a user for illegal uses. To determine accounts that may be impersonating an entity many entities or interest parties may employ methods that utilize a machine learning models to determine an impersonation. An impersonation may refer to an entity or user pretending to be another entity by using a name, photo, voice, or any other suitable method associated with the other entity. Conventionally, many of the machine learning models may be trained on data that is manually labeled and/or combined with inferred labels. Some methods of inferring data labels may be using random negatives, side signal-based labels, label augmentation, or the like. However, current machine learning models may be biased to detect impersonations of larger, high-profile entities but fail to accurately detect impersonations of smaller entities. The bias may be due to the machine learning models being trained on an imbalanced dataset that makes predictions based on a victim ID, which does not accurately capture impersonation behaviors. As such, these machine learning models may be less accurate when less frequent victims get impersonated. There may be a need for a more accurate machine learning model for determining impersonations.

Disclosed herein are methods, systems, or apparatuses, which may generate synthetic data to rebalance the training set for machine learning models utilized to determine impersonations. Rebalancing the training dataset may improve the accuracy of impersonation determinations by machine learning models. Rebalancing the training data set may aid in solving the impersonation problem, wherein the impersonation problem refers to if one entity (responsible) pretends to be another entity by using the name, photo, speaking voice, or any other method associated with another entity. The machine learning model may predict whether the entity is impersonating another entity or not based on a responsible, victim pair. In many examples, the potential victims are predefined as a ‘seed set’ in which to prevent impersonation against.

In an example, for high profile seeds (e.g., entities) which may have many positive labels (e.g., true imposter) in the training dataset, the generated synthetic data may comprise more synthetic negative labels (e.g., no impersonation). Conversely, for seeds (e.g., entities) which do not appear often in the manual labeled dataset (e.g., entities that are not commonly identified as being impersonated), additional synthetic positive labels may be generated to reinforce a ‘similarity detection’ concept for the model.

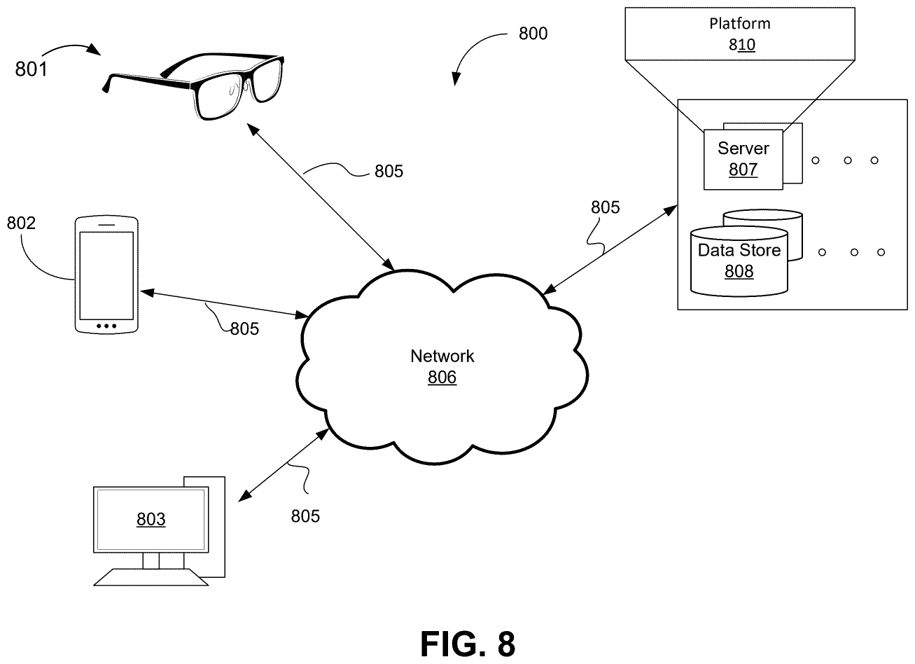

FIG. 8 illustrates an example system 800 that may implement a platform 810. The system 800 may be capable of facilitating communications among users or provisioning of content among users. System 800 may include one or more communication devices 801, 802, and 803 (also may be referred to as user devices), server 807, data store 808, or platform 810. As shown for simplicity, platform 810 may be located on server 807. It is contemplated that platform 810 may be located on or interact with one or more devices of system 800. It is contemplated that platform 1810 may be a feature or native component of a third-party platform or device (e.g., device 802, 803). Additionally, system 800 may include any suitable network, such as, for example, network 806.

In an example, device 801, device 802, and device 803 may be associated with an individual (e.g., a user or an entity) that may interact or communicate with platform 810. platform 810 may be considered, or associated with, an application, a messaging platform, a social media platform, or the like. In some examples, one or more users may use one or more devices (e.g., device 801, 802, 803) to access, send data to, or receive data from platform 810 which may be located on server 1807, device (e.g., device 801, 802, 803), or the like.

This disclosure contemplates any suitable network 806. As an example and not by way of limitation, one or more portions of network 806 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. In some examples, network 806 may include multiple networks 806.

Links 1805 may connect device 1801, device 1802, or device 1803 to platform 1810 to network 806, or to each other. This disclosure contemplates any suitable links 805. In particular examples, one or more links 805 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular examples, one or more links 805 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 805, or a combination of two or more such links 805. Links 805 need not necessarily be the same throughout network 806 or system 800. One or more first links 805 may differ in one or more respects from one or more second links 805.

Devices 1801, 1802, 1803 may be an electronic device including hardware, software, or embedded logic components or a combination of two or more such components and capable of carrying out the appropriate functionalities implemented or supported by the devices 801, 802, 803. As an example and not by way of limitation, devices 801, 802, 803 may be a computer system such as for example, a desktop computer, notebook or laptop computer, netbook, a tablet computer (e.g., smart tablet), e-book reader, global positioning system (GPS) device, personal digital assistant (PDA), handheld electronic device, cellular telephone, smartphone, augmented/virtual reality device, other suitable electronic device, or any suitable combination thereof. This disclosure contemplates any suitable device(s) (e.g., devices 801, 802, 803). One or more of the devices 801, 802, 803 may enable a user to access network 806. One or more of the devices 801, 802, 803 may enable a user(s) to communicate with other users at other devices 801, 802, 803.

In particular examples, system 800 may include one or more servers 807. Each of the servers 807 may be a unitary server or a distributed server spanning multiple computers or multiple datacenters. Servers 807 may be of various types, such as, for example and without limitation, web server, news server, mail server, message server, advertising server, file server, application server, exchange server, database server, proxy server, another server suitable for performing functions or processes described herein, or any combination thereof. In particular examples, each of the servers 807 may include hardware, software, or embedded logic components or a combination of two or more such components for carrying out the appropriate functionalities implemented or supported by server 807.

In particular examples, system 800 may include one or more data stores 808. Data stores 1808 may be used to store various types of information. In particular examples, the information stored in data stores 808 may be organized according to specific data structures. In particular examples, each of the data stores 808 may be a relational, columnar, correlation, or other suitable database. Although this disclosure describes or illustrates particular types of databases, this disclosure contemplates any suitable types of databases. Particular examples may provide interfaces that enable devices 801, 802, 803 or another system (e.g., a third-party system) to manage, retrieve, modify, add, or delete, the information stored in data store 1808.

In particular examples, platform 810 may be a network-addressable computing system that may host an online search network. Platform 810 may generate, store, receive, or send user information (also referred herein as user data) associated with a user, such as, for example, user-profile data (e.g., user online presence), geographical location, previous searches, interactions with content, or other suitable data related to the platform 810. Platform 810 may be accessed by one or more components of system 800 directly and/or via network 1806. As an example and not by way of limitation, device 801 may access platform 810 located on server 807 by using a web browser, feature of a third-party platform (e.g., function of a social media application, function of an AR application), or a native application on device 801 associated with platform 810 (e.g., a messaging application, a social media application, another suitable application, or any combination thereof) directly or via network 806.

In particular examples, platform 810 may store one or more user profiles associated with an online presence in one or more data stores 808. In particular examples, a user profile may include multiple nodes—which may include multiple user nodes (each corresponding to a particular user associated with a device 801, device 802, or device 803) or multiple concept nodes (each corresponding to a particular role or concept)—and multiple edges connecting the nodes. Users of the platform 810 may have the ability to communicate and interact with other users. In particular examples, users associated with a particular device (e.g., device 801) may join the platform 810 and then add connections (e.g., relationships) to a number of other users or entities (e.g., device 802, 803) constituting contacts or connections of platform 810 to whom they want to communicate with or be connected with. In some examples, user connections or communications may be monitored for machine learning purposes. In an example, server 807 of platform 810 may receive, record, or otherwise obtain information associated with communications or connections of users or entities (e.g., device 801, device 802, or device 803). As such, the monitored connections or communications may be utilized for determining trends related to a user (e.g., entity) or one or more connections associated with the user profile.

In particular examples, platform 810 may provide users with the ability to take actions on various types of items. As an example, and not by way of limitation, the items may include groups to which a user may belong, messaging boards in which a user might be interested, question forums, interactions with images, stories, videos, comments under a post, emails, messages, or other suitable items. A user may interact with anything that is capable of being represented in platform 810. In particular examples, platform 810 may be capable of linking a variety of users (e.g., entities). As an example, and not by way of limitation, platform 810 may enable users (e.g., entities) to interact with each other as well as receive media (e.g., video, audio, text, or the like, or any combination thereof) from their respective group (e.g., associated with a number of connections), wherein the group may refer to a chosen plurality of users that may be communicating or interacting through application programming interfaces (API) or other communication channels to each other. It is contemplated that user may also refer to an entity (e.g., organization, business, or the like), wherein an entity may have a user profile associated with the platform 810 at which they communicate with other users or entities.

In an example, platform 810 may employ a machine learning model configured to determine whether a user (e.g., entity) (e.g., device 801) is impersonating another user (e.g., device 802 or device 803) or not. In some examples, individuals that work for platform 810 may have the ability to send, receive, or change data associated with platform 810. In some examples, individuals that work for platform 810 may aid in the labeling of training data utilized to train the machine learning model configured to determine user impersonations.

Although FIG. 8 illustrates a particular arrangement of device 801, 802, 803, network 806, server 807, data store 808, or platform 810, among other things, this disclosure contemplates any suitable arrangement. The devices of system 800 may be physically or logically co-located with each other in whole or in part.

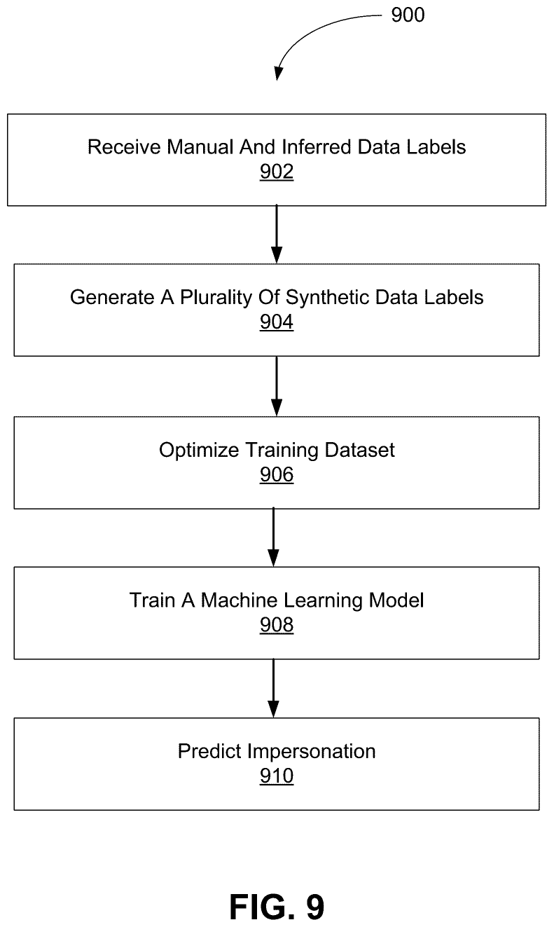

FIG. 9 illustrates an example method 900 for generating a plurality of synthetic data associated with a training dataset utilized to train a machine learning model (e.g., machine learning model 1210). In some examples, a training dataset may be a collection of data points, each consisting of input features and corresponding target labels or outputs, that are used to train and fine-tune machine learning models (e.g., machine learning model 1210). Synthetic data may be artificially generated data points that may mimic the characteristics and patterns of real-world data (e.g., the set of manual labels and the set of inferred labels). In some examples, synthetic data may be generated to create new examples or data points of underrepresented labels. The plurality of synthetic data may include a plurality of synthetic positive samples and a plurality of synthetic negative samples. The method 900 may begin at 902, where data labels may be received. In an example, the data labels may be determined manually (e.g., a set of manual labels) by an individual (e.g., group of reviewers) that works for a platform 810, wherein the individual may determine based on received information or data associated with a user to label if a potential responsible account (e.g., user) is impersonating a potential victim account (e.g., another user). In some examples, the potential victim account (e.g., a user that is authentic) may be determined via processes associated with the platform. For example, one or more social media applications may determine that a user is a potential victim account based on a stable verification indicator, such as a blue check associated with the user account. The users having a stable verification indicator may be considered authentic (e.g., not an impersonation) unless they have been identified as being compromised or impersonated by the user. In some examples, a user may link a first account associated with a first social media platform that may have a stable verification indicator and a second account associated with a second social media platform. In such an example, due to the user's accounts (e.g., first account and second account) being linked, when the user may have an account (e.g., first account) that has a stable verification indicator on the first social media platform the user may be verified or considered authentic on the second social media platform. Manually labeling (e.g., a set of manual labels) may refer to a process of manually adding labels or annotations to data points by human annotators (e.g., an individual, group of reviewers, or the like). In some examples, the process of manually labeling may involve assigned relevant categories, tags, labels, or classifications to each data point, such as text, images, audio, or the like, to create a labeled dataset that may be used to train a machine learning model. The individual associated with the platform 810 may determine impersonation based on a number of factors such as but not limiting to platform polices, review protocols, or the like. It is contemplated that in some examples, an individual or a user may be a specialized machine running a machine learning model specifically trained to performed actions and methods as described herein.

In some examples, based on the data received labels associated with the user may be inferred (e.g., a set of inferred labels) as to whether a potential responsible account (e.g., user) is impersonating a potential victim account (e.g., another user). In some examples, inferred labeling may refer to a process that may utilize algorithms and techniques to automatically generate labels or annotations to data points. In some examples, inferred labeling may analyze patterns, relationships, and structures within the data to infer labels. For example, a potential responsible account (e.g., a user) and a potential victim account (e.g., another user) have an indicated connection via platform 810, the potential responsible account and potential victim account interact with each other's posts on platform 810. There is more interaction with the potential victim account to the potential responsible account—as such it may be inferred to label this data associated with this interaction as no impersonation. In some examples, the manually determined labels and inferred labels may be stored in a database (e.g., data store 808) associated with platform 810.

At 904, a plurality of synthetic data labels may be generated. The type (e.g., synthetic negative label or synthetic positive label) and number of synthetic data generated may be determined based on the number of labels determined to be positive (e.g., indicating impersonation) and negative (e.g., indicating no impersonation) at block 902. For example, if 100 labels are determined at block 902, where 40 have positive labels and 60 have negative labels, a plurality of synthetic labels may be generated. The synthetic negative labels may be configured to pair with the number of positive labels determined at block 902 (e.g., 40 negative labels may be synthetically generated). Conversely, the synthetic positive labels may be configured to duplicate unique seed ID pairs (e.g., victim ID pairs). In this example, there may be 80 unique seed IDs therefore, there may be 80 synthetic positive labels generated.

At 906, all or most of the labels from block 902 and block 904 may be processed to optimize the training dataset. As such some data processing methods may be performed to ensure the training dataset is ready to train a machine learning model (e.g., machine learning model 1210). The methods performed may include but are not limited to adjusting sample distribution, optimize train-valid-test split, label quality-based filtering, or any other suitable method.

The optimal train-valid-test split may be a data processing method that involves dividing a dataset into three parts for machine learning model development and evaluation. The process may begin with data preparation, collecting and preprocessing the dataset, handling any missing values or outliers. Next, the dataset may be divided into three parts: a training set, which is used for model training and hyperparameter tuning and typically may include 60-80% of the dataset; a validation set, used for model evaluation and hyperparameter tuning during training, may include 15-20% of the dataset; and a testing set, used for final model evaluation and performance measurement, may include 10-20% of the dataset. The division is typically done using random splitting to ensure the three sets are representative of the overall dataset, and stratified splitting may be used if the dataset is imbalanced to maintain the same class balance in each set. Finally, a machine learning model may be trained on the training set, hyperparameters are tuned using the validation set, and the final model is evaluated on the testing set, providing a more accurate measure of its performance and reducing overfitting.

The adjusting sample distribution may be a data processing method used to address class imbalance issues in datasets, where one class has a significantly larger number of instances than others. This method may involve modifying the distribution of the training data to balance the classes (e.g., in this case labels), ensuring that the model is equally representative of all classes. Techniques used to adjust sample distribution may include oversampling the minority class, under-sampling the majority class, generating synthetic samples, or using class weights or loss functions that penalize the model for misclassifying minority class instances. By adjusting the sample distribution, a machine learning model may be trained to be more sensitive to the minority class, improving its performance and generalization on underrepresented classes.

Label quality-based filtering may be a data processing method that involves identifying and removing or correcting poorly labeled or erroneous data points from a dataset. This method recognizes that real-world datasets often contain noisy or incorrect labels, which can negatively impact machine learning model performance. By applying label quality-based filtering, mislabeled datapoints may be detected and adjusted, such as datapoints with incorrect or missing labels, outliers, or inconsistencies. Techniques used in this method may include data visualization, statistical analysis, and machine learning-based approaches like active learning and uncertainty estimation. By removing or correcting poor-quality labels, the dataset may be refined, enabling machine learning models to learn more accurately and generalize better to new, unseen data.

At 908, a machine learning model 1210, may be trained based on the combination of manually labeled data, inferred labeled data, and the plurality of synthetic data labels. At 910, the machine learning model 1210 may predict whether a user (e.g., entity) is impersonating another user or entity.

FIG. 9 illustrates an example flow 1000 associated with building the training dataset of a machine learning model 1210 configured to predict whether a user (e.g., entity) is impersonating another user or entity. At 1001, data associated with a potential responsible account may be assessed and manually attached a label by an individual or group of reviewers associated with platform 810. The manually attached labels may be considered a set of manual labels. The group of reviewers (e.g., an individual) may follow certain rules and protocols to determine if a user (e.g., entity) is impersonating another user or entity. The manual review labels may be data pairs associated with data of responsible (e.g., potential impersonating account) and victim accounts.

At 1002, behavioral labels may be added to data associated with users (e.g., entities) based on a knowledge graph. The knowledge graph may be a directed graph, where users (e.g., entities) are the vertices and the interactions/behaviors between one or more users are the edges. The knowledge graph may help infer if an entity has a legitimate relationship with a user and may not an impersonation of either the user or the entity. For example, certain behaviors such as, ‘a user follow another user,’ ‘a user comment under another user's post,’ ‘a potential imposter page has an admin who's also an admin of the potential victim page,’ or the like, may be assessed on the knowledge graph to make inferences based on the behavior whether a user or an entity is an impersonation or if the behavior monitored (e.g., or assessed) corresponds to an impersonation. The behavioral labels determined may be considered a set of inferred labels. The labels attached to data here, may not be determined manually or with human assistance. For example, a potential responsible user and a potential victim user may follow each other on a social media platform (e.g., platform 810) and both user's may interact with each other's posts. There are more interactions with the potential victim user to the potential responsible user, therefore, it may be inferred that this interaction between the two users may be labeled or defined as non-impersonation behavior. In another example, some businesses may franchise branches of their organization at specific locations. In such an example, an owner, business manager, account administrator or the like (e.g., a user) may monitor a number of user accounts associated with each branch of an organization they may be associated with. As such this behavior may be indicated (e.g., labeled) as non-impersonation behavior.

At 1003, the manual labels of block 1001 and the inferred labels of 1002 may be combined in a database (e.g., data store 808) associated with a platform (e.g., platform 810). The labels stored in the database may be of the form seed ID, candidate ID, label, or any other suitable format. Seed ID may indicate an identification of a potential victim user account, candidate ID may indicate an identification of a potential responsible user account, and the label may be negative (e.g., no impersonation) or positive (e.g., an impersonation).

At 1004, a plurality of synthetic data labels may be generated. For example, 35 labels are stored in the database of block 1003, there are 30 positive labels and 5 negative labels. In this example, 30 synthetic negative labels may be generated to pair with the 30 positive labels of block 1003. The candidate ID for the synthetically generated negative labels may be associated with a random user. Now the number of labels will be 30 positive labels, 5 negative labels, and 30 synthetically generated labels—in total there are now 30 positive labels and 35 negative labels. In this example, the probability of this user being an imposter may be 30 positive labels out of 65 total labels which yields about a 46% chance that the user is an impersonation. Conversely, in some systems the probability of an impersonation may have been 30 positive labels out of 35 total labels yielding about an 86% chance that the user is impersonating another user, which may lead to a false positive determination of a user impersonating another user account. Referring back to the initial example, synthetic positive labels may be utilized to reinforce the idea of similarity detection. The synthetic positives may be utilized to train the machine learning model 1210 to predict the likelihood of impersonation. In an example, impersonation may be determined by a degree of similarity between the seed ID and the candidate ID. Synthetic positives may be indicative of the same seed ID and candidate ID (e.g., indicating the seed ID and candidate ID may be 100% similar). As such, the machine learning model 1210 may learn from the similarity of the seed ID and candidate ID (e.g., 100% for synthetic positive) and predict positive, thus reinforcing the similarity detection power of the model (e.g., machine learning model 1210). Therefore, the slight variations in the seed ID and candidate ID may be assessed and determined whether it is an impersonation.

At 1205, the labels, e.g., labels from block 1003 and labels form block 1004, may be optimized to create a training dataset to be utilized to train a machine learning model 1210. The process of block 1005 may also be considered a union of real labels (e.g., manually labels and inferred labels) and synthesized labels (e.g., of block 1004). There may be multiple machine learning solutions utilized at block 1005 to optimize the training dataset to optimize model training performance.

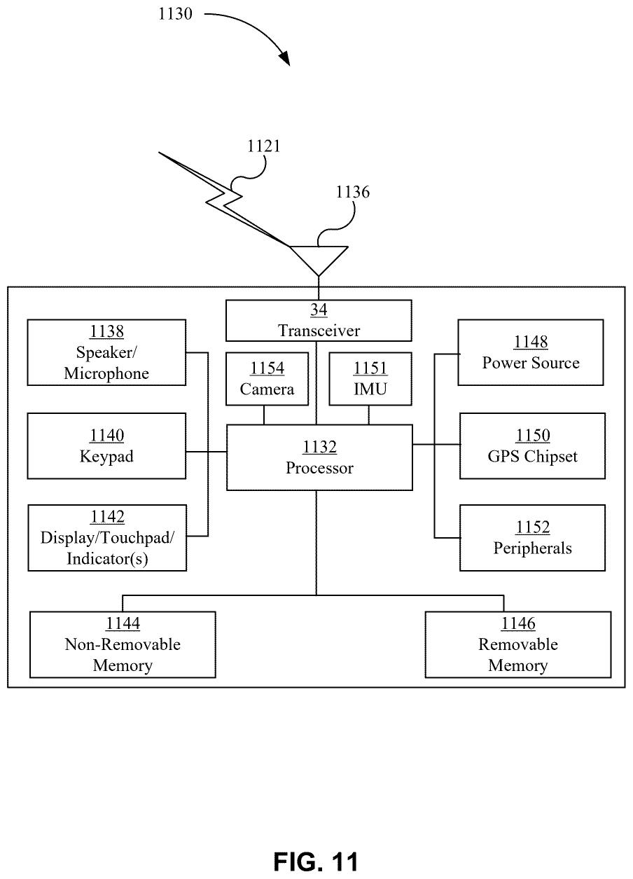

FIG. 11 illustrates a block diagram of an example hardware/software architecture of user equipment (UE) 1130. As shown in FIG. 11, the UE 1130 (also referred to herein as node 1130) may include a processor 1132, non-removable memory 1144, removable memory 1146, a speaker/microphone 1138, a keypad 1140, a display, touchpad, and/or indicators 1142, a power source 1148, a global positioning system (GPS) chipset 1150, an inertial measurement unit (IMU) 1151, and other peripherals 1152. The UE 1130 may also include a camera 1154. In an example, the camera 1154 is a smart camera configured to sense images appearing within one or more bounding boxes. The UE 1130 may also include communication circuitry, such as a transceiver 1134 and a transmit/receive element 1136. It will be appreciated that the UE 1130 may include any sub-combination of the foregoing elements while remaining consistent with an example.

The processor 1132 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 1132 may execute computer-executable instructions stored in the memory (e.g., memory 1144 and/or memory 1146) of the node 1130 in order to perform the various required functions of the node. For example, the processor 1132 may perform signal coding, data processing, power control, input/output processing, and/or any other functionality that enables the node 1130 to operate in a wireless or wired environment. The processor 1132 may run application-layer programs (e.g., browsers) and/or radio access-layer (RAN) programs and/or other communications programs. The processor 1132 may also perform security operations such as authentication, security key agreement, and/or cryptographic operations, such as at the access-layer and/or application layer for example.

The processor 1132 is coupled to its communication circuitry (e.g., transceiver 1134 and transmit/receive element 1136). The processor 1132, through the execution of computer executable instructions, may control the communication circuitry in order to cause the node 30 to communicate with other nodes via the network to which it is connected.

The transmit/receive element 1136 may be configured to transmit signals to, or receive signals from, other nodes or networking equipment. For example, in an example, the transmit/receive element 1136 may be an antenna configured to transmit and/or receive radio frequency (RF) signals. The transmit/receive element 1136 may support various networks and air interfaces, such as wireless local area network (WLAN), wireless personal area network (WPAN), cellular, and the like. In yet another example, the transmit/receive element 1136 may be configured to transmit and receive both RF and light signals. It will be appreciated that the transmit/receive element 1136 may be configured to transmit and/or receive any combination of wireless or wired signals.

The transceiver 1134 may be configured to modulate the signals that are to be transmitted by the transmit/receive element 1136 and to demodulate the signals that are received by the transmit/receive element 1136. As noted above, the node 1130 may have multi-mode capabilities. Thus, the transceiver 1134 may include multiple transceivers for enabling the node 1130 to communicate via multiple radio access technologies (RATs), such as universal terrestrial radio access (UTRA) and Institute of Electrical and Electronics Engineers (IEEE 802.11), for example.

The processor 1132 may access information from, and store data in, any type of suitable memory, such as the non-removable memory 1144 and/or the removable memory 1146. For example, the processor 1132 may store session context in its memory, as described above. The non-removable memory 1144 may include RAM, ROM, a hard disk, or any other type of memory storage device. The removable memory 1146 may include a subscriber identity module (SIM) card, a memory stick, a secure digital (SD) memory card, and the like. In other examples, the processor 1132 may access information from, and store data in, memory that is not physically located on the node 1130, such as on a server or a home computer.

The processor 1132 may receive power from the power source 1148 and may be configured to distribute and/or control the power to the other components in the node 1130. The power source 1148 may be any suitable device for powering the node 30. For example, the power source 1148 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 1132 may also be coupled to the GPS chipset 1150, which may be configured to provide location information (e.g., longitude and latitude) regarding the current location of the node 1130. It will be appreciated that the node 1130 may acquire location information by way of any suitable location-determination method while remaining consistent with an example.

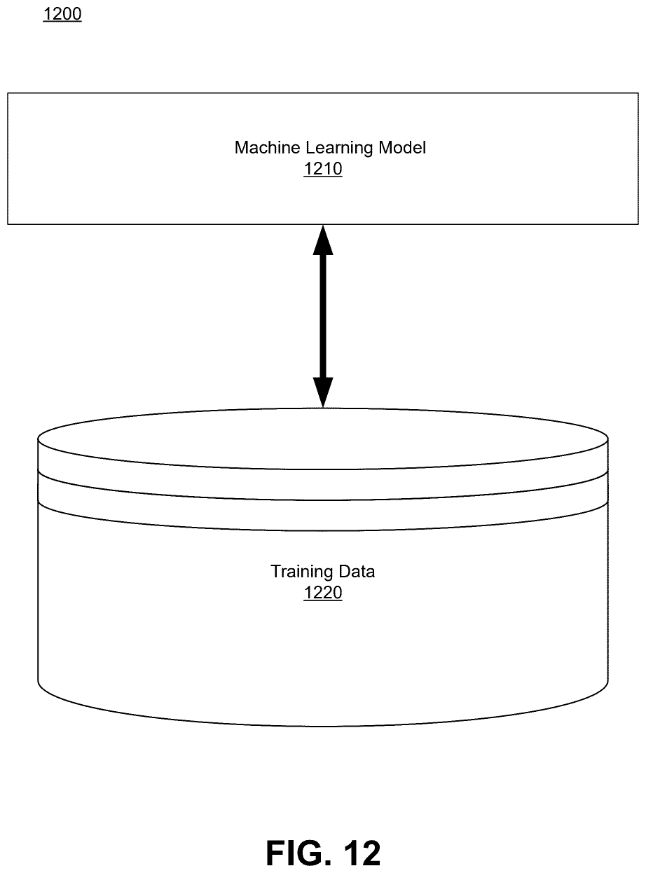

FIG. 12 illustrates a framework 1200 that may be employed by the platform 810 associated with machine learning. The framework 1200 may be hosted remotely. Alternatively, the framework 1200 may reside within the system 800 as shown in FIG. 8 or be processed by a device (e.g., devices 801, 802, 803). The machine learning model 1210 may be operably coupled with the stored training data in a database (e.g., data store 808). In some examples, the machine learning model 1210 may be associated with other operations. The machine learning model 1210 may be implemented by one or more machine learning models(s) (e.g., machine learning model 1210) or another device (e.g., server 807, or device 801, 802, 803).

In another example, the training data 1220 may include attributes of thousands of objects. For example, the object may be a smart phone, person, book, newspaper, sign, car, item and the like. Attributes may include but are not limited to the size, shape, orientation, position of the object, etc. The training data 1220 employed by the machine learning model 1210 may be fixed or updated periodically. Alternatively, the training data 1220 may be updated in real-time based upon the evaluations performed by the machine learning model 1210 in a non-training mode. This is illustrated by the double-sided arrow connecting the machine learning model 1210 and stored training data 1220. In operation, the machine learning model 1210 may evaluate associations between labels and user behaviors to determine whether a user is impersonating another user.

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features described in connection with any one or more examples are not intended to be excluded from a similar role in any other examples.

### D. Systems And Methods For Deploying State-Of-The-Art Generative Artificial Intelligence Models To Recommendation Systems

### TECHNOLOGICAL FIELD

The present disclosure generally relates to systems and methods for generating content items.

### BACKGROUND

Electronic devices are constantly changing and evolving to provide users with flexibility and adaptability. Some electronic devices may employ platforms, third-party applications, or the like to provide content (e.g., advertisements, products, services, posts, images, videos, etc.) via to users. In many examples, the content provided via electronic devices may be interactive. As such, interactions with content may be associated or stored in an online presence (e.g., user account) associated with a user on a platform. In some examples, the content may include products, items, or advertisements associated with a brand, an activity of interest, or the like. Such information may be useful to platform developers to ensure that the content displayed to users, increase user engagement, and potentially increase purchases in the example of advertisements. Knowing an association between user profiles and content may be an important criterion for platform developers and/or advertisers. However, due to the sheer amount of data associated with the generation of content (e.g., images, products, services, videos, advertisements, etc.) that may be available to a platform, device, or the like, current technology may face significant challenges in computational time (e.g., latency) and/or computational efficiency (e.g., computational constraints).

### SUMMARY

Various systems, methods, and devices are described for generating top ranked content items.

Content generated may include advertisements (e.g., product ads, content ads, or the like), product recommendations, search results, content recommendations, promotions, suggested media (e.g., video, audio, image, or the like) to a user, a user account, an online profile, or any other suitable type of online presence. The top ranked content items may be generated by a machine learning system.

In various examples, systems and methods may receive an indication of an incoming request associated with the user (e.g., user profile) accessing a platform. A machine learning model may identify user profile data associated with the incoming request. A second machine learning model may be applied, wherein the second machine learning model may be trained on an output associated with a first machine learning model. The first machine learning model may be trained on a plurality of content items and a plurality of user profiles associated with a platform. The first machine learning model may be configured to determine an association between the plurality of content items and the plurality of user profiles. The first machine learning model may determine a score associated with each of the plurality of content items in association to each of the plurality of user profiles. Each score may be compared to a predetermined threshold, wherein values below the threshold may be removed from the data set providing a subset of content items of the plurality of content items as the output. The second machine learning model may be trained on the output may further determine an association between the user associated with the incoming request and the subset of content items of the plurality of content items. The second machine learning model may be configured to score the associations determined, where top ranked content items may be determined. In some examples, the top ranked content items may be ranked within a predetermined threshold ranking. The top ranked content items may have a score above the predetermined threshold. The top ranked content items may be generated by the machine learning system to be presented or provided to a user.

Various systems, methods, and devices are described for generating top ranked content items, via a machine learning system. Systems and methods may receive an indication of an incoming request associated with the user (e.g., user profile) accessing a platform. A machine learning model may identify user profile data associated with the incoming request. A first machine learning model may be trained on a plurality of content items and a plurality of user profiles associated with a platform. The first machine learning model may be configured to determine an association between the plurality of content items and the plurality user profiles. The first machine learning model may determine a score associated with each of the plurality of content items in association to each of the user profiles of the plurality of user profiles. Each score may be compared to a predetermined threshold, wherein values below the threshold may be removed from the data set providing a subset of the plurality of content items as the output. A second machine learning model may be trained on the output of the first machine learning model may further determine an association between the user associated with the incoming request and the subset of the plurality of content items. The second machine learning model may be configured to score the associations determined, where top ranked content items may be determined. The top ranked content items may be generated by the machine learning system to be presented or provided to a user.

### Description

As participation in online platforms, such as social media platforms, content may need to be provided to users. At any time, a user may appear on an online platform, developers may need to provide a user with a personalized digital experience. In many examples, the personalized digital experience may be specifically designed for a specific user within a specific ecosystem (e.g., type of device, browser, location, etc.). The digital experience on such online platforms may include a plurality of content items such as but not limited to organic content (e.g., a set of stories, reels, news, people you may know (e.g., other users), groups you may know, or the like, or any combination thereof), or advertisements. As an example, as a user log into an online platform (e.g., a social media platform) developers must provide a plurality of content items as “user digital experience.” The user digital experience may be greatly affected by the quality and/or relevance of the content items presented. In many examples, there may be many variables and factors that may influence the content items being presented to the user such as but not limited to user data, user interests, groups associated with the user, or any other suitable data type. However, with the vast amount of data as well as the complexity of the data it may be take a long time to present the best or optimal content items to a user.

As such, systems and methods are disclosed herein for generating top ranked content items. In some examples, a first machine learning model may be trained offline on every content item and every user profile and its associated user data to determine scores associated with relevance for each content item for each user of a plurality of user profiles. The output of the first machine learning model may be utilized to train a second machine learning model, which may further limit a subset of the content items to top ranked content items to be presented to the user. The second machine learning model may score a subset of the plurality of content items (e.g., output of the first machine learning model) in relation to user profile data to determine top ranked content items. The top ranked content items may refer to one or more content items with the highest determined score above a predetermined threshold.

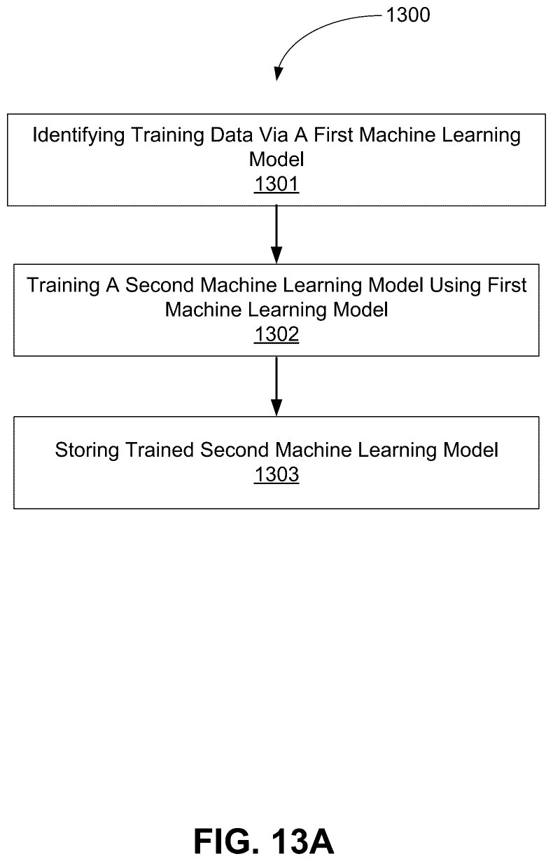

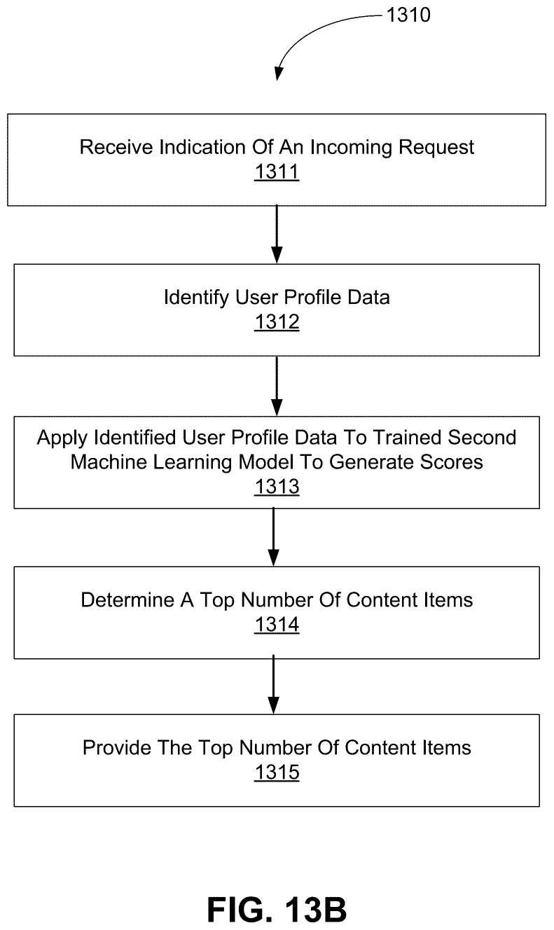

FIG. 13A illustrates an example method 1300 for training a first machine learning model, in accordance with an example of the present disclosure. The method 1300 may be implemented by a machine learning system associated with platform 810 as described herein.

At 1301, a first machine learning model may identify training data. Training data may include user data and content data. This may involve conversion of identified training data into numerical representations between zero and one. For example, in the context of advertisements, input data (e.g., training data) may include user profile data that may utilize a plurality of data points from historical user interactions with content, user interests, or the like for a plurality of different users (e.g., every user with access to the platform). The input data (e.g., training data), may include numerical representations of advertisement features that may utilize a plurality of data points from a form associated with the advertisement (e.g., image, video, text, or the like), number of interactions with an advertisement, context associated with the advertisement, number of times an advertisement has been sent to a user, popularity of an advertisement, or the like, or any combination thereof.

The output data can include a score indicating a relevance associated with each content item in relation to a user profile. In the example of advertisements, the score may indicate a weighted relevance of a particular advertisement in relation to a user profile. For example, there are ten advertisement features and ten advertisements for a user profile, the first machine learning model may be applied to assign weights to each advertisement (e.g., W₁ to W₁₀) and to each advertisement feature (e.g., V₁ to V₁₀) in relation to the user profile data. The first machine learning model may determine the relevance of the advertisement based on a score between the weights of each advertisement and advertisement feature (e.g., the weights of each may be added or any other mathematical function). The machine learning model may comprise a predetermined threshold associated with the scores, wherein if the score is below the threshold the advertisement may be removed from the output. The predetermined threshold may be any number between 0 and 1, e.g., 0.3 or any other suitable value. Theoretically going from millions of advertisements to thousands of advertisements in a dataset (e.g., the output). It is contemplated that the method of block 201 may be conducted “off-line,” wherein off-line may refer to a moment or time window when a user is not interacting with platform 810. In some examples, the time “off-line” may be predicted via user profile data to conduct the methods of block 1301 at a time where a user is not normally interacting with platform 810.

At 1302, a second machine learning model may be trained on the output of the first machine learning model using the identified training data, via a method called transfer learning. Transfer learning may be a method at which a machine learning model (e.g., the second machine learning model) may leverage knowledge gained from one task (e.g., output of the first machine learning model) or dataset and apply it to another task or dataset. Transfer learning may enable the second machine learning model to be fine-tuned for a specific target task or dataset. By doing so transfer learning may improve the second machine learning models performance and reduce the need of retraining a machine leaning model from scratch. As such, it is contemplated that the steps and methods of block 1302 may be performed when a user is “online,” e.g., a user is interacting with platform 810. The second machine learning model may utilize the weights and scores determined via the first machine learning model to further limit the number of content items relevant to a user. For example, the first machine learning model may have been trained on millions of advertisements wherein, conversely, the second machine learning model may be trained on thousands of advertisements that are outputted from the first machine learning model. The second machine learning model may be configured to determine weights and scores similar to how the first machine learning model determines weights and scores associated with content items. The weights and scores determined via the second machine learning model may be compared to the weights and scores of the first machine learning model using the first machine learn model as a baseline, benchmark, or a ground truth associated with the training data (e.g., identified training data).

The second machine learning model may output top ranked content items indicated to be relevant to a user, wherein the top ranked content items may be determined by the platform 810, for example, the top ranked content items may be 10 advertisements with the highest score determined by the second machine learning model.

At 1303, the machine learning system may store the results of the first machine learning model and/or the second machine model for use in generating scores (e.g., representing relevance of a content item in respect to a user profile). For example, the machine learning system may provide the trained first machine learning model to the second machine learning model to determine top ranked content items relevant to a user associated with a user profile.

FIG. 13B illustrates a method 1310 for using the second machine learning model to generate top ranked content items according to an example of the present disclosure. At 1311, an indication of an incoming request may be received, wherein the incoming request may be associated with a user associated with a user device (e.g., device 801) accessing or interacting with a platform (e.g., platform 810). At 1312, machine learning system may identify user profile data that may correspond to input features or identified input data associated with the first machine learning model of block 1301 of the method 1300 of FIG. 13A. For example, the second machine learning model may mine historical user data, device usage, user interactions with content, a user interests, or the like or any combination thereof. At 1313, the machine learning system may input the user profile data into the trained second machine learning model to generate scores. For example, a numerical representation (e.g., vector or decimal form) of user profile data may be provided to the second machine learning model as an input. The second machine learning model may then determine scores associated with the received user profile data and the trained data received from the first machine learning model. For example, a score may be determined for a user profile in real-time (e.g., at the instance a user is interacting with platform 810), wherein the score may be an association of the user profile data and content features. For example, in the example of advertisements, scores may be determined in association to a plurality of advertisements in relation to the received user profile data.

At 1314, the machine learning system may identify top ranked content items based on the scores determined via the second machine learning model. The top ranked content items may include any number of content items determined by the system to be optimal for use experience. For example, the top ranked content items may be ten advertisements to present to the user. In some examples, the top ranked content items may be a percentage of the total number of content items at which the second machine learning model may be trained on (e.g., 5%, 10% or the like of the number of content items). The top ranked content items may be associated with content items with the highest scores determined by the second machine learning model above a predetermined threshold, wherein the predetermined threshold may be any number between zero and one determined by platform 810. Due to the face that the second machine learning model is trained on a subset of the total number of content items, computational demands and latency of computational actions may be minimized. For example, the presentation of advertisements may have a required latency of 600 milliseconds, without this method it may take hours for a system to comb through millions of diverse and complex content items to present to a user, however, with the use of a second machine learning model trained on a subset of the content items the latency and computational constraints associated with determining a content item is greatly decreased and may be scalable depending on the latency and computational restraints associated with the platform (e.g., platform 810), user experience, or the request associated with the platform 810.

At 1315, the machine learning system may present the top ranked content items to a user via a graphical user interface associated with a user device (e.g., device 801). In some examples, the machine learning system may store the top ranked content items for future presentation to the user.

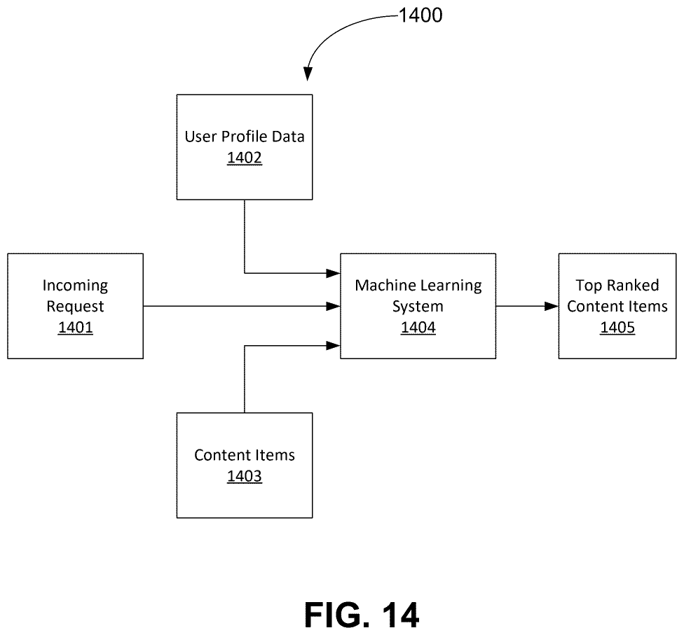

FIG. 14 illustrates an example flowchart 1400, in accordance with an example of the present disclosure. The flowchart 1400 may be employed (e.g., utilized) via a platform 810. The flowchart 1400 may be performed by a machine learning system 1404 to optimize (e.g., limit) a plurality of content items to a subset of the plurality of content items, via a first machine learning model, and to top ranked content items, via a second machine learning model, to be presented to a user. The machine learning system 1404 may comprise a number of machine learning models, wherein the machine learning models may be large language models.

The machine learning system 1404 may be configured to develop an association, based on an incoming request 1401 between a user profile associated with a user profile data 1402 and a plurality of content items 1403 (e.g., one or more of a number of posts, videos, photos, reels, stories, advertisements, products, or any suitable content item(s) or combination thereof). Top ranked content items 1405 may be generated based on the association between the user profile data 1402 and the number of content items 1403. In some examples the machine learning system 1404 may generate the top ranked content items 1405. The top ranked content items 1405 may include content associated with a platform (e.g., platform 810) or the incoming request 1401. The incoming request 1401 may be initiated by a user accessing platform 810, wherein particular implementations of the platform 810 may determine the content associated with platform 810. In some examples, the incoming request may define the content item indexed or referenced in the plurality of content items 1403, for example a content inventory or database may be referenced to determine the type of content to be referenced. For example, platform 810 is associated with an online marketplace, as such when a user, via device 801 (e.g., user device), accesses the platform 810, wherein the flowchart 1400 may be initiated and a machine learning system 1404 may be implemented. The plurality of content items 1403 may include (e.g., store) a plurality of advertisements. In this example, the machine learning system 1404 may determine an association between the user profile data 302 and a plurality of advertisements (e.g., plurality of content items 1403). The association may be scored and utilized to generate top ranked content items 1405, wherein the top ranked content items 1405 may be representative of advertisements (e.g., content items) that may have the most relevance to a user associated with a user profile.

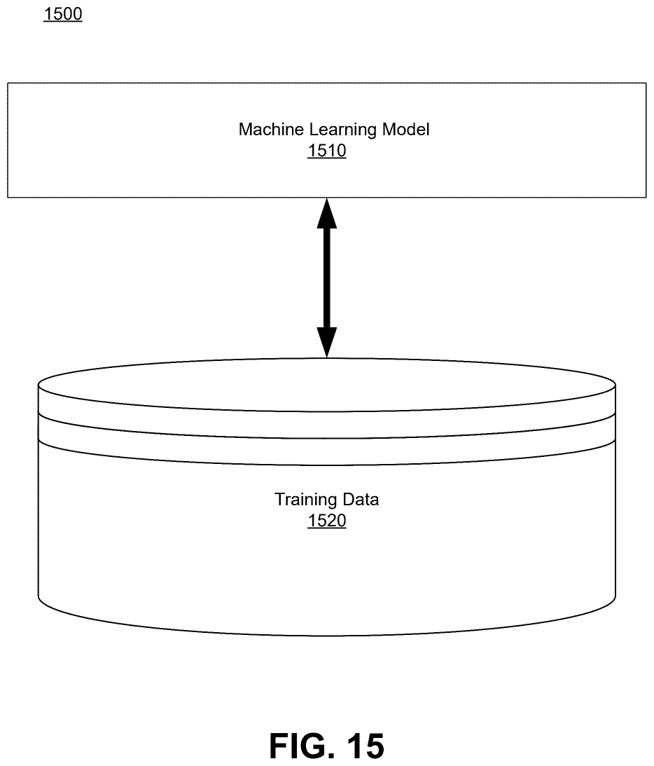

FIG. 15 illustrates a framework 1500 that may be employed by the platform 810 associated with machine learning. The framework 1500 may be hosted remotely. Alternatively, the framework 1500 may reside within the system 800 as shown in FIG. 8 or be processed by a device (e.g., devices 801, 802, 803). The machine learning model 1510 may be operably coupled with the stored training data in a database (e.g., data store 808). In some examples, the machine learning model 1510 may be associated with other operations. The machine learning model 1510 may be implemented by one or more machine learning models(s) (e.g., machine learning system of 1404) or another device (e.g., server 807, or device 801, 802, 803).

In another example, the training data 520 may include attributes of thousands of objects. For example, the object may be a smart phone, person, book, newspaper, sign, car, item and the like. Attributes may include but are not limited to the size, shape, orientation, position of the object, etc. The training data 820 employed by the machine learning model 1510 may be fixed or updated periodically. Alternatively, the training data 1520 may be updated in real-time based upon the evaluations performed by the machine learning model 1510 in a non-training mode. This is illustrated by the double-sided arrow connecting the machine learning model 1510 and stored training data 1520.

In operation, the machine learning model 1510 may evaluate associations between a plurality of content items and user profile data. For example, user profile data (e.g., user device usage, interactions with content, or the like, or any combination thereof) may be compared with respective attributes of stored training data 1520 (e.g., prestored objects).

Typically, such determinations may require a large quantity of manual annotation and/or brute force computer-based annotation to obtain the training data in a supervised training framework. However, aspects of the present disclosure, deploys a machine learning model that may utilize an optimized training dataset utilizing generated synthetic data labels. Due to the training dataset the machine learning model may be flexible, adaptive, automated, temporal, learns quickly and trainable. Manual operations or brute force device operations are unnecessary for the examples of the present disclosure due to the learning framework and dual neural network model aspects of the present disclosure. As such, this enables the user recommendations of the examples of the present disclosure to be flexible and scalable to billions of users, and their associated communication devices, on a global platform.

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out or conducted in various ways. Examples of specific implementations are provided herein for illustrative purposes only and are not intended to be limiting. In particular, acts, elements and features described in connection with any one or more examples are not intended to be excluded from a similar role in any other examples.

What is claimed:

1. A method comprising:
utilizing one or more large language models (LLMs) to generate probability distributions to facilitate one or more binary classification tasks associated with specific user item pairs;
utilizing the generated probabilities to rank one or more tasks;
training the one or more LLMs based on utilizing Knowledge Distillation methods and by incorporating a dual-label system associated with hard labels and soft labels, wherein one or more items of training data of the one or more LLMs comprise the user item pairs and corresponding features associated with the user item pairs;
utilizing labels in the training, wherein the labels comprise binary classification labels and respective probabilities associated with the binary classification labels; and
implementing the trained one or more LLMs to determine rankings or recommendations associated with user engagement of one or more content items.

2. The method of claim 1, wherein the one or more content items are associated with the user item pairs.

3. A method comprising:
receiving, by a device, an input associated with a user;
training a dual encoder model on user characteristics and content features to determine an association between user data and predictive user actions;
training a machine learning model on information associated with the dual encoder model and the input;
generating a recommendation based on the association between data associated with the dual encoder model and the input; and
sending the recommendation, to a device.

4. The method of claim 3, wherein the dual encoder model may comprise one or more databases that store data associated with the user.

5. The method of claim 3, wherein the dual encoder model may comprise one or more large language models.

6. The method of claim 5, wherein a first large language model is trained based on user characteristics comprising data associated with user characteristics and sequential events.

7. The method of claim 5, wherein a second large language model is trained based on content features comprising data associated with application features and user engagement.

8. The method of claim 3, wherein the machine learning model generates the recommendation.

9. A method comprising:
receiving a set of manual labels and a set of inferred labels;
generating a plurality of synthetic data labels configured to balance a positive label or a negative label associated with the set of manual labels and the set of inferred labels;
training a machine learning model on a training dataset comprising the set of manual labels, the set of inferred labels, and the plurality of synthetic data labels; and
predicting, via the machine learning model, whether a user is impersonating another user.

10. The method of claim 9, wherein the set of the manual labels are determined by a group of reviewers associated with a platform.

11. The method of claim 9, wherein the set of inferred labels are determined based on a knowledge graph and indicated behavioral labels.

12. The method of claim 9, wherein the plurality of synthetic data labels comprises a plurality of synthetic negative data labels and a plurality of synthetic positive data labels.

13. The method of claim 9, comprising a union of the set of manual labels and the set of inferred labels in a database.

14. The method of claim 13, wherein the database stores the set of the manual labels and the set of inferred labels in a form comprising a seed identifier (ID), a candidate ID, and a label.

15. The method of claim 14, wherein the seed ID indicates the user has a potential to be a victim of impersonation.

16. The method of claim 14, wherein candidate ID indicates the user that has a potential to be impersonate another user.

17. A method comprising:
training a first machine learning model via an identified training data;
training a second machine learning model based on an output of the first machine learning model; and
storing the trained first machine learning model.

18. The method of claim 17, wherein the identified training data comprises a plurality of content items and user profile data.

19. The method of claim 18, wherein the plurality of the content items is one or more of a plurality of advertisements, images, videos, texts, stories, reels, or other user accounts.

20. The method of claim 17, wherein the first machine learning model is configured to provide a plurality of scores to a subset of a plurality of content items as the output.
